SEQUENCE LISTING (8 sequences)

SEQ ID NO: 1 - DNA, 621 bp, Saccharomyces cereviseae
  CDS (1)...(621): *
atgagctttatggatcaaatcccaggaggaggaaattatccaaaactcccagtagaatgccttcctaacttcccgatccaaccatctttgaccttcagaggtagaaatgactcgcataaactgaaaaactttatctccgaaataatgttaaacatgtctatgatatcttggccgaatgatgccagtcgtattgtgtactgcagaagacatttattaaaccccgctgctcagtgggctaatgactttgtacaagaacaaggtatacttgaaataacattcgacacattcatacaaggattatatcagcatttctataagccaccagatatcaataaaatctttaatgcaatcacgcaactttccgaagctaaacttggtattgagcgtctcaaccaacgattcagaaagatttgggacagaatgccaccagacttcatgaccgaaaaagctgccataatgacatatactaggctattgacaaaggaaacctataatattgtcagaatgcacaaaccagagacattaaaagacgccatggaagaggcttaccagacaactgcactaactgaaagattcttcccaggattcgaacttgatgctgatggagacactatcatcggt

SEQ ID NO: 2 - protein, 207 aa, Saccharomyces cereviseae
MSFMDQIPGGGNYPKLPVECLPNFPIQPSLTFRGRNDSHKLKNFISEIMLNMSMISWPNDASRIVYCRRHLLNPAAQWANDFVQEQGILEITFDTFIQGLYQHFYKPPDINKIFNAITQLSEAKLGIERLNQRFRKIWDRMPPDFMTEKAAIMTYTRLLTKETYNIVRMHKPETLKDAMEEAYQTTALTERFFPGFELDADGDTIIG

SEQ ID NO: 3 - DNA, 621 bp, Artificial Sequence
  CDS (1)...(621)
  Chemically Synthesized
atgtcattcatggaccagattccgggcgggggtaactatcctaaattgccagtagaatgtttgccgaattttcccattcaaccaagtctgacctttcgcgggagaaacgatagccacaaactgaagaatttcattagcgagattatgctcaacatgtcgatgatctcttggcctaacgatgcgtctagaattgtgtactgccgtcgtcatttacttaatccagctgctcagtgggctaatgactttgtgcaagaacagggtattctcgagattacgttcgatacatttatccaggggctgtatcaacacttttataaaccgcctgatatcaataaaatctttaacgccatcacgcagctgtccgaggcaaaattaggcattgaacgtctgaatcaacggtttcggaaaatttgggatcgcatgccaccagatttcatgacagaaaaggccgcaattatgacgtatacccggttactgacgaaagagacctataatattgtacgtatgcataagccggagaccctgaaagatgcgatggaggaagcctaccagaccactgcccttaccgaacgattcttccctggctttgaactggacgcggacggagataccatcataggc

SEQ ID NO: 4 - protein, 207 aa, Artificial Sequence; identical to SEQ ID NO: 2
  Chemically Synthesized

SEQ ID NO: 5 - DNA, 621 bp, Artificial Sequence
  CDS (1)...(621)
  Chemically Synthesized
atgagtttcatggaccagattccgggtggtggtaactaccctaaactgccggttgaatgcctgccgaactttccgatccagcctagcctgacctttcgtggtcgtaacgatagccacaaacttaaaaacttcattagcgaaatcatgctgaacatgagtatgatcagctggccgaatgacgctagccgtatcgtttactgtcgtcgtcacctgcttaaccccgctgcgcaatgggctaatgacttcgttcaggaacagggtatcctggagatcacctttgacaccttcatccagggcctgtaccagcacttctataaaccgcctgacattaacaaaatcttcaacgcgatcacccaactgagcgaggcgaaactgggtatcgaacgtctgaaccagcgtttccgaaaaatttgggaccgtatgccgcccgacttcatgaccgaaaaagctgcgatcatgacctacacccgtctgctgactaaagaaacctacaacatcgttcgtatgcacaaaccggaaacccttaaagacgctatggaagaagcataccagaccaccgctctgaccgaacgtttcttcccaggtttcgaacttgacgcggacggtgacaccatcatcggt

SEQ ID NO: 6 - protein, 207 aa, Artificial Sequence; identical to SEQ ID NO: 2
  Chemically Synthesized

SEQ ID NO: 7 - DNA, 693 bp, HIV-1
  CDS (1)...(693)
cctatagtgcagaacatccaggggcaaatggtacatcaggccatatcacctagaactttaaatgcatgggtaaaagtagtagaagagaaggctttcagcccagaagtaatacccatgttttcagcattatcagaaggagccaccccacaagatttaaacaccatgctaaacacagtggggggacatcaagcagccatgcaaatgttaaaagagaccatcaatgaggaagctgcagaatgggatagagtacatccagtgcatgcagggcctattgcaccaggccagatgagagaaccaaggggaagtgacatagcaggaactactagtacccttcaggaacaaataggatggatgacaaataatccacctatcccagtaggagaaatttataaaagatggataatcctgggattaaataaaatagtaagaatgtatagccctaccagcattctggacataagacaaggaccaaaagaaccttttagagactatgtagaccggttctataaaactctaagagccgagcaagcttcacaggaggtaaaaaattggatgacagaaaccttgttggtccaaaatgcgaacccagattgtaagactattttaaaagcattgggaccagcggctacactagaagaaatgatgacagcatgtcagggagtaggaggacccggccataaggcaagagttttg

SEQ ID NO: 8 - protein, 231 aa, HIV-1
PIVQNIQGQMVHQAISPRTLNAWVKVVEEKAFSPEVIPMFSALSEGATPQDLNTMLNTVGGHQAAMQMLKETINEEAAEWDRVHPVHAGPIAPGQMREPRGSDIAGTTSTLQEQIGWMTNNPPIPVGEIYKRWIILGLNKIVRMYSPTSILDIRQGPKEPFRDYVDRFYKTLRAEQASQEVKNWMTETLLVQNANPDCKTILKALGPAATLEEMMTACQGVGGPGHKARVL

(19) United States
(12) Patent Application Publication
(10) Pub. No.: US 2008/0046192 A1
(43) Pub. Date: Feb. 21, 2008

(54) Polypepetide-encoding nucleotide sequences with refined translational kinetics and methods of making same

(76) Inventors: Richard Lathrop, Irvine, CA (US); G. Wesley Hatfield, Corona del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/505,781

(22) Filed: Aug. 16, 2006

(51) Int. Cl. G06F 19/00

(52) U.S. Cl. 702/20

(57) ABSTRACT

Provided are methods for creating a synthetic gene for expression in a host organism, by providing a data set representative of codon pair translational kinetics for the host organism which includes translational kinetics values of the codon pairs utilized by the host organism, providing a desired polypeptide sequence for expression in the host organism, and generating a polynucleotide sequence encoding the polypeptide sequence by analyzing candidate nucleotides to select, where possible, codon pairs that are predicted not to cause a translational pause in the host organism, with reference to the data set, thereby providing a candidate polynucleotide sequence encoding the desired polypeptide. The methods can be performed using multiple parameter nucleotide sequence optimization methods, such as branch-and-bound methods for nucleotide sequence refinement.

### FEDERALLY SPONSORED RESEARCH

The work resulting in this invention was supported in part by National Science Foundation Grant No. IIS-0326037 and National Institutes of Health Grant No. STTR 1R41-AI-066758. The U.S. Government may therefore be entitled to certain rights in the invention.

### BACKGROUND

1. Field of the Invention

The present invention relates to new methods for refining the translational kinetics of an mRNA into polypeptide, and polypeptide-encoding nucleotide sequences which have refined translational properties.

2. Description of the Related Art

The expression of foreign heterologous genes in transformed organisms is now commonplace. A large number of mammalian genes, including, for example, murine and human genes, have been successfully inserted into single celled organisms. Despite the burgeoning knowledge of expression systems and recombinant DNA, significant obstacles remain when one attempts to express a foreign or synthetic gene in an organism. Often, a synthetic gene, even when coupled with a strong promoter, is inefficiently translated and produces a faulty protein. The same is frequently true of exogenous genes foreign to the expression organism. Even when the gene is translated in a sufficiently efficient manner that recoverable quantities of the translation product are produced, the protein is often inactive, insoluble, aggregated, or otherwise different in properties from the native protein.

The protein coding regions of genes in all organisms are subject to a wide variety of functional constraints, some of which depend on the requirement for encoding a properly functioning protein, as well as appropriate translational start and stop signals. However, several features of protein coding regions have been discerned which are not readily understood in terms of these constraints: two important classes of such features are those involving codon usage and codon context.

It has been known for a considerable time that codon utilization is highly biased and varies considerably between different organisms. The possibility that biases in codon usage can alter peptide elongation rates has been widely discussed, but while differences in codon use are thought to be associated with differences in translation rates, direct effects of codon choice on translation have been difficult to demonstrate. Additional proposed constraints on codon usage patterns include maximizing the fidelity of translation and optimizing the kinetic efficiency of protein synthesis. Replacing rarely used codons with frequently used codons may improve protein expression.

Apart from the non-random use of codons, evidence indicates that codon/anticodon recognition is influenced by sequences outside the codon itself, a phenomenon termed “codon context.” Although the context effect has been recognized by previous researchers, the predictive value of most statistical rules relating to preferred nucleotides adjacent to codons is relatively low. This, in turn, has severely limited the utility of such nucleotide preference data for selecting codons to effect desired levels of translational efficiency.

In one study (U.S. Pat. No. 5,082,767), it was found that codon pair utilization was biased, reflecting over-representation or under-representation of various codon pairs relative to expected codon pair frequencies. This codon utilization bias varies in different types of organisms. Using chi-squared analysis, U.S. Pat. No. 5,082,767 showed that over-represented codon pairs of a known nucleotide sequence in its native organism could be identified, and these chi-squared values could be plotted for codons encoding protein regions. However, a graphical representation of chi-squared values such as that of U.S. Pat. No. 5,082,767 does not reflect the relative degree by which codon pairs are over-represented or under-represented. In addition, the magnitude of chi-squared values calculated according to U.S. Pat. No. 5,082,767 varies from calculation to calculation and from organism to organism depending on the amount of data input into the chi-squared analysis. These shortcomings result in graphical representations that are difficult to use, both in terms of using the graph to evaluate possible modification of a codon sequence, and in terms of comparing the graphs for expression in different organisms. In particular, scaling differences from graph to graph increases the ambiguity of evaluating sequence modifications and/or expression in different organisms. In addition, the chi-squared values have been used to estimate translational kinetics for proteins. However, such estimates are only a first approximation, and do not represent true predictions of translational kinetics. Heretofore, shortcomings in chi-squared based predictions of translational kinetics have not been appreciated.

Furthermore, it has proved to be difficult to develop methods of refining translational kinetics of polypeptide expression according to the observations of U.S. Pat. No. 5,082,767 in combination with additional factors influencing the translational kinetics of polypeptide expression (e.g., codon usage).

### SUMMARY

Some translational pauses are resultant from the presence of particular codon pairs in the nucleotide sequence encoding the polypeptide to be translated. As provided herein, inappropriate or excessive translation pauses can reduce protein expression considerably. Further, the translational pausing properties of codon pairs can vary from organism to organism. As a result, exogenous expression of genes foreign to the expression organism can lead to inefficient translation. Even when the gene is translated in a sufficiently efficient manner that recoverable quantities of the translation product are produced, the protein is often inactive, insoluble, aggregated, or otherwise different in properties from the native protein. Thus, removing inappropriate or excessive translation pauses can improve protein expression. Accordingly, provided herein is a polypeptide-encoding nucleotide in which predicted translation pauses have been removed or reduced, methods of making such polypeptide-encoding nucleotides, and methods of expressing such polypeptide-encoding nucleotides. The resultant polypeptide-encoding nucleotide is predicted to be translated rapidly along its entire length. Expression of the resultant polypeptide-encoding nucleotide is predicted to result in improved protein expression levels in cases where inappropriate or excessive translation pauses reduce protein expression. In addition, expression of the resultant polypeptide-encoding nucleotide is predicted to result in improved levels of active and/or natively folded polypeptide expression in cases where inappropriate or excessive translation pauses causes expression of inactive, insoluble, aggregated polypeptide.

In accordance with the above, provided herein are methods for creating a synthetic gene for expression in a host organism, by providing a data set representative of codon pair translational kinetics for the host organism which includes translational kinetics values of the codon pairs utilized by the host organism, providing a desired polypeptide sequence for expression in the host organism, and generating a polynucleotide sequence encoding the polypeptide sequence by analyzing candidate nucleotides to select, where possible, codon pairs that are predicted not to cause a translational pause in the host organism, with reference to the data set, thereby providing a candidate polynucleotide sequence encoding the desired polypeptide. The methods provided herein can be performed using multiple parameter nucleotide sequence optimization methods, such as branch-and-bound methods for nucleotide sequence refinement.

Also provided herein are methods for creating a synthetic gene for expression in a host organism, by providing a first data set representative of codon pair translational kinetics for the host organism which includes translational kinetics values of the codon pairs utilized by the host organism, providing a second data set representative of at least one additional desired property of the synthetic gene, providing a desired polypeptide sequence for expression in the host organism, and generating a polynucleotide sequence encoding the polypeptide sequence by analyzing candidate nucleotides to select, where possible, both (i) codon pairs that are predicted not to cause a translational pause in the host organism, with reference to the first data set, and (ii) nucleotides that provide a desired property, with reference to the second data set, thereby providing a candidate polynucleotide sequence encoding the desired polypeptide. In some embodiments, the second data set is of codon preferences representative of codon usage by the host organism, including the most common codons used by the host organism for a given amino acid. The methods provided herein can further include analyzing the candidate polynucleotide sequence to confirm that no codon pairs are predicted to cause a translational pause in the host organism by more than 5, or 3, or 2, or 1.5 standard deviations, and that codon utilization is non-randomly biased in favor of codons most commonly used by the host organism.

In some embodiments, provided herein are methods for creating a synthetic gene for expression in a host organism, by providing a first data set of codon preferences that is representative of codon usage by the host organism, including the most common codons used by the host organism for a given amino acid; providing a second data set representative of codon pair translational kinetics for the host organism, including likelihood of causing a translational pause resulting from codon pairs utilized by the host organism; providing a desired polypeptide sequence for expression in the host organism, said polypeptide sequence including at least twenty amino acids; and generating a polynucleotide sequence encoding the polypeptide sequence by analyzing candidate codons for each amino acid of said desired polypeptide and analyzing candidate codons for each adjacent amino acid of said desired polypeptide, to select, where possible, both (i) codons that are most commonly used by the host organism, with reference to the first data set, and (ii) codon pairs that are not likely to cause a translational pause in the host organism, with reference to the second data set, thereby providing a candidate polynucleotide sequence encoding the desired polypeptide. Some such methods, further include analyzing the candidate polynucleotide sequence to confirm that no codon pairs have a likelihood of causing a translational pause in the host organism that is greater than a selected threshold likelihood level, and that codon utilization is nonrandomly biased in favor of codons most commonly used by the host organism. In some such methods, the generating step includes identifying at least one instance of a conflict between selecting common codons and avoiding codon pairs likely to cause a translational pause; and resolving the conflict in favor of avoiding codon pairs likely to cause a translational pause. In some such methods, the generating step includes generating a candidate polynucleotide sequence encoding the polypeptide sequence; altering at least one codon of the candidate polynucleotide sequence to change a codon pair likely to cause a translational pause to a codon pair that is less likely to cause a translational pause, without altering the amino acid encoded thereby; replacing at least one codon of the candidate polynucleotide sequence with a codon that is more commonly used in the host organism, without altering the amino acid encoded thereby; after altering the candidate polynucleotide sequence, comparing the altered polynucleotide sequence with at least a portion of the first data set; after altering the candidate polynucleotide sequence, comparing the altered polynucleotide sequence with at least a portion of the second data set; individually repeating these steps a plurality of times, in any order, thereby altering a plurality of codons encoding a plurality of amino acids of said candidate polynucleotide sequence. In some such methods, the candidate polynucleotide sequence of the analyzing step is analyzed to confirm that no codon pairs are likely to cause a translational pause in the host organism by more than about 5, or 3, or 2, or 1.5 standard deviations. In some such methods, the generating step further comprises analyzing at least a portion of the candidate polynucleotide sequence in frame shift, and selecting codons for said candidate polynucleotide sequence such that stop codons are added to at least one said frame shift. In some such methods, the generating step further comprises providing a third data set, and analyzing at least a portion of the candidate sequence to reduce or eliminate occurrences of the property in the third data set, wherein the property of the third data set is selected from the group consisting of restriction site, Shine-Dalgarno sequence, occurrence of 5 consecutive G's, occurrence of 5 consecutive C's, occurrence of 6 consecutive A's, occurrence of 6 consecutive T's, long exactly repeated subsequence, and user-prohibited sequence. In some such methods, the generating step further comprises providing a third data set, and analyzing at least a portion of the candidate sequence to reduce or eliminate occurrences of the property in the third data set, wherein the property of the third data set is selected from the group consisting of occurrence of RNA splice site, occurrence of polyA site, and occurrence of Kozak translation initiation sequence. In some such methods, the generating step further comprises providing a third data set, and analyzing at least a portion of the candidate sequence to contain or increase the presence of a property in the third data set, wherein the property of the third data set is selected from the group consisting of Shine-Dalgarno translation initiation sequence, of Kozak translation initiation sequence, and out of frame stop codon. In some such methods, at least 50% of the codon pairs predicted to cause a translational pause are removed. In some such methods, at least 50% of the codon pairs having a translational kinetics value at least 5, or 3, or 2, or 1.5 standard deviations above the mean are removed. In some such methods, the resultant polynucleotide sequence is a synthetic polynucleotide sequence. In some such methods, the resultant polynucleotide sequence has less than 50% identity to the original polynucleotide sequence. In some such methods, the amino acid sequence encoded by the resultant polynucleotide sequence is at least 90% identical to the original amino acid sequence. In some such methods, the resultant polynucleotide sequence does not contain a codon pair having a translational kinetics value at least 5, or 3, or 2, or 1.5 standard deviations above the mean located in a region within an autonomous folding unit of the encoded polypeptide. In some such methods, the second data set contains translational kinetics values corresponding to each codon pair for a particular host organism. In some such methods, the translational kinetics values are based, at least in part, on a value selected from the group consisting of: normalized chi squared value of observed codon pair frequency versus expected codon pair frequency in the host organism; empirical measurement of the translational kinetics of a codon pair in the host organism; determination of a translational kinetics value of observed codon pair frequency versus expected codon pair frequency conserved across two or more species at a boundary location between autonomous folding units of a protein present in the two or more species, wherein the group of two or more species includes the host organism; translational kinetics value of observed codon pair frequency versus expected codon pair frequency that is positionally conserved across two or more species for a protein present in the two or more species, wherein the group of two or more species includes the host organism; and determination of a codon pair conserved across two or more proteins of the host organism at boundary locations between autonomous folding units of the two or more proteins.

### BRIEF DESCRIPTION OF THE DRAWINGS

FIG. 1 depicts effects of Translational Engineering on Protein Expression Levels. FIG. 1A depicts Western blots of the Saccharomyces cereviseae retrotransposon Ty3 Capsid protein expressed from codon optimized (see FIG. 1B), hot-rod (see FIG. 1C), and native (see FIG. 1D) genes induced at two arabinose concentrations in equal numbers of E. coli cells harvested at mid-log growth at 37° C. in LB broth. FIGS. 1B-E depict graphical displays of z scores of chi-squared values for codon pair utililization of nucleic acid sequences encoding the capsid of the Ty3 retrotransposon of S. cerevisiae, plotted as a function of codon pair position. FIG. 1B depicts a graphical display of the Escherichia coli expression of a nucleic acid sequence encoding the Ty3 capsid which has been modified to optimize codon usage for expression in E. coli. FIG. 1C depicts a graphical display of the E. coli expression of a nucleic acid sequence encoding the Ty3 capsid which has been modified to eliminate codon pairs that are over-represented in E. coli. FIG. 1D depicts a graphical display of the E. coli expression of the native nucleic acid sequence encoding the Ty3 capsid. FIG. 1E depicts a graphical display of the S. cereviseae expression of the native nucleic acid sequence encoding the Ty3 capsid.

FIG. 2 depicts graphical displays of z scores of chi-squared values for codon pair utililization of nucleic acid sequences encoding the capsid protein of the human immunodeficiency virus, HIV-1, and the capsid protein of the S. cereviseae retrotransposon, Ty3. (A) HIV-1. (B) Ty3. The ribbon structure of each protein (as known or predicted) is shown above the respective graphical display. The regions of the abscissa indicating the amino terminal and the carboxy terminal domains of each protein are indicated by brackets. The thick black horizontal lines identify the positions of alpha helices in each protein.

FIG. 3 depicts a flow chart of the process for refining a nucleotide sequence that encodes a polypeptide to be expressed. The general computational framework is described in “Multi-Queue Branch-and-Bound Algorithm for Anytime Optimal Search with Biological Applications,” Lathrop, R. H., Sazhin, A., Sun, Y., Steffen, N., Irani, S., pp. 73-82 in Proc. Intl. Conf. on Genome Informatics, Tokyo, Dec. 17-19, 2001, Genome Informatics 2001 (Genome Informatics Series No. 12), Universal Academy Press, Inc., which is incorporated in its entirety by reference.

FIG. 4 provides the nucleotide and amino acid sequences depicted in FIGS. 1 and 2 and described in Examples 1 and 2.

### DETAILED DESCRIPTION

Some translational pauses are resultant from the presence of particular codon pairs in the nucleotide sequence encoding the polypeptide to be translated. As provided herein, inappropriate or excessive translation pauses can reduce protein expression considerably. Further, the translational pausing properties of codon pairs can vary from organism to organism. As a result, exogenous expression of genes foreign to the expression organism can lead to inefficient translation. Even when the gene is translated in a sufficiently efficient manner that recoverable quantities of the translation product are produced, the protein is often inactive, insoluble, aggregated, or otherwise different in properties from the native protein. Thus, removing inappropriate or excessive translation pauses can improve protein expression. Accordingly, provided herein is a polypeptide-encoding nucleotide in which predicted translation pauses have been removed or reduced, methods of making such polypeptide-encoding nucleotides, and methods of expressing such polypeptide-encoding nucleotides. The resultant polypeptide-encoding nucleotide is predicted to be translated rapidly along its entire length. Expression of the resultant polypeptide-encoding nucleotide is predicted to result in improved protein expression levels in cases where inappropriate or excessive translation pauses reduce protein expression. In addition, expression of the resultant polypeptide-encoding nucleotide is predicted to result in improved levels of active and/or natively folded polypeptide expression in cases where inappropriate or excessive translation pauses causes expression of inactive, insoluble, aggregated polypeptide.

In accordance with the above, provided herein are methods for creating a synthetic gene for expression in a host organism, by providing a data set representative of codon pair translational kinetics for the host organism which includes translational kinetics values of the codon pairs utilized by the host organism, providing a desired polypeptide sequence for expression in the host organism, and generating a polynucleotide sequence encoding the polypeptide sequence by analyzing candidate nucleotides to select, where possible, codon pairs that are predicted not to cause a translational pause in the host organism, with reference to the data set, thereby providing a candidate polynucleotide sequence encoding the desired polypeptide. The methods provided herein can be performed using multiple parameter nucleotide sequence optimization methods, such as branch-and-bound methods for nucleotide sequence refinement.

Also provided herein are methods for creating a synthetic gene for expression in a host organism, by providing a first data set representative of codon pair translational kinetics for the host organism which includes translational kinetics values of the codon pairs utilized by the host organism, providing a second data set representative of at least one additional desired property of the synthetic gene, providing a desired polypeptide sequence for expression in the host organism, and generating a polynucleotide sequence encoding the polypeptide sequence by analyzing candidate nucleotides to select, where possible, both (i) codon pairs that are predicted not to cause a translational pause in the host organism, with reference to the first data set, and (ii) nucleotides that provide a desired property, with reference to the second data set, thereby providing a candidate polynucleotide sequence encoding the desired polypeptide. In some embodiments, the second data set is of codon preferences representative of codon usage by the host organism, including the most common codons used by the host organism for a given amino acid. The methods provided herein can further include analyzing the candidate polynucleotide sequence to confirm that no codon pairs are predicted to cause a translational pause in the host organism by more than 5, or 3, or 2, or 1.5 standard deviations, and that codon utilization is non-randomly biased in favor of codons most commonly used by the host organism.

### Changes to Translational Kinetics

The methods and sequences provided herein permit modification of the translational kinetics of an mRNA into polypeptide. Translational kinetics of an mRNA into polypeptide can be changed in order to achieve any of a variety of expression profiles. For example, translational kinetics of an mRNA into polypeptide can be changed in order to remove some or all translational pauses. In another example, translational kinetics of an mRNA into polypeptide can be changed in order to remove some or all translational pauses predicted to occur within an autonomous folding unit of a nascent protein. In another example, translational kinetics of an mRNA into polypeptide can be changed in order to remove some or all over-represented codon pairs.

It is proposed herein that the presence of a pause or translation slowing codon pair can queue ribosomes back to the beginning of the coding sequence, thereby inhibiting further ribosome attachment to the message which can result in down-regulation of protein expression levels as the rate of translation initiation readily saturates and the slowest translation step becomes rate limiting. It is also proposed herein that the presence of a pause or translational slowing codon pair can stall or detach a ribosome. It is also proposed herein that the presence of a pause or translational slowing codon pair can expose naked mRNA, which is then subject to message degradation. It is also proposed herein that the presence of a pause or translational slowing codon pair can decouple translation from transcription, leading to protein expression failure. For these reasons and more, methods for analyzing and designing gene sequences to remove or decrease the number of pauses or translational slowing codon pairs have great utility.

Organism-specific codon usage and codon pair usage, and the presence of organism-specific pause sites, result in gene translation that is highly adapted to its original host organism. For example, ribosomal pausing sites that may be functional in a human cell will typically not be recognized in a bacterium. A heterologous cDNA has a random but high probability of encoding a pause site somewhere, often leading to protein expression failure.

Differences between pause signal coding among bacteria or among vertebrates are sufficient to make cross-family gene expression unpredictable. For example, in various organisms such as bacteria, a significant pause or translational slowing can result in premature transcription termination and/or messenger degradation. Even in eukaryotes there is a coupling between export of mRNA from the nucleus and translation; thus a different, but still effective system of clearing untranslated mRNA exists in eukaryotes.

As provided herein, a test of translation pausing or slowing as a result of codon pair usage can be performed by comparing a series of genes that have random pauses with modified genes where codon pairs predicted to cause translational pauses are removed. Unmodified genes moved from their source organism and expressed in a heterologous host can have an altered set of codon pairs predicted to cause a translational pause or slowing (e.g., an altered set of over-represented codon pairs), resulting in altered configuration of presumed pause sites. Creation of synthetic codon-pair-optimized genes can have a dramatic effect on expression: expression of difficult-to-express genes can be seen for the first time or improved at least 2-fold, 3-fold, 4-fold, 5-fold, 6-fold, 7-fold, 8-fold, 9-fold, 10-fold, 12-fold, 15-fold, 20-fold, 25-fold, 30-fold, or more, relative to unmodified polypeptide-encoding nucleic acid sequences.

In some embodiments, translational kinetics of an mRNA into polypeptide can be changed in order to remove some or all translational pauses or other codon pairs that cause translational slowing. While not intending to be limited to the following, it is believed that, for at least some proteins, reduction or elimination of translational pauses can serve to increase the expression level and/or quality of the protein. Accordingly, by removing some or all translational pauses or other codon pairs that cause translational slowing, the expression levels and/or quality of an expressed protein can be increased. Thus, also provided herein are polypeptide-encoding nucleotide sequences that have been modified to have one or more transcription pause or slowing sites removed by modifying one or more codon pairs to a corresponding codon pair that is less likely to cause a translational pause or slowing. While in some embodiments it is preferred to remove all codon pairs predicted to cause a translational pause or slowing, in other embodiments, it is sufficient to remove a subset of codon pairs predicted to cause a translational pause or slowing. For example, expression levels can be increased by removing at least 1, 2, 3, 4, 5, 6, 7, 8, 9, 10 or more codon pairs predicted to cause a translational pause or slowing. In another example, at least 10%, 20%, 30%, 40%, 50%, 60%, 70%, 75%, 80%, 85%, 90%, 95%, 97%, 98% or 99% of codon pairs predicted to cause a translational pause or slowing are removed by, for example, substituting different codon pairs that encode the same amino acids.

In some embodiments, translational kinetics of an mRNA into polypeptide can be changed in order to remove some or all translational pauses predicted to occur within an autonomous folding unit of a protein. As used herein, an “autonomous folding unit of a protein” refers to an element of the overall protein structure that is self-stabilizing and often folds independently of the rest of the protein chain. Such autonomous folding units typically correspond to a protein domain. As provided herein, expression of a gene in a heterologous host organism can result in translational pauses located in regions that inhibit protein expression and/or protein folding. Since the presence of codon pairs predicted to cause a translational pause or slowing in protein-encoding regions separating regions encoding different autonomous folding units of the protein can serve to pause or slow translation, it is also contemplated that removal of translational pauses predicted to occur within an autonomous folding unit of a protein, particularly for heterologously expressed proteins, can result in improved expression levels and/or folding of expressed proteins. Accordingly, provided herein are methods of changing translational kinetics of an mRNA into polypeptide by removing some or all translational pauses predicted to occur within an autonomous folding unit of a protein, thereby increasing expression levels and/or improving the folding of expressed proteins.

In the methods provided herein that include changing translational kinetics of an mRNA into polypeptide by modifying codon pairs with regard to their location within or outside of autonomous folding units of proteins, one step can include identifying predicted autonomous folding units of a protein. Methods for identifying predicted autonomous folding units of a protein or protein domains are known in the art, and include alignment of amino acid sequences with protein sequences having known structures, and threading amino acid sequences against template protein domain databases. Such methods can employ any of a variety of software algorithms in searching any of a variety of databases known in the art for predicting the location of protein domains. The results of such methods will typically include an identification of the amino acids predicted to be present in a particular domain, and also can include an identification of the domain itself, and an identification of the secondary structural element, if any, in which each amino acid sequence of a domain is located.

In some instances, it is not possible to modify the polypeptide-encoding nucleotide sequence to remove a translational pause not present in the expression profile of the polypeptide in the native host organism. For example, there may be no codon pairs that are not predicted to cause a translational pause or slowing and that encode a corresponding pair of amino acids. In such instances, several options are available: the codon pair that is least likely to cause a translational pause or slowing can be selected; an amino acid insertion, deletion or mutation can be introduced to yield a codon pair that is not predicted to cause a translational pause or slowing; or no change is made. One option in a computerized method is to request human input in order to resolve the issue. Alternatively, the computer may be programmed to make a selection. In methods in which an amino acid insertion, deletion or mutation is made in order to change translational kinetics, it is preferable to select a change that is predicted not to substantially influence the final three-dimensional structure of the protein and/or the activity of the protein. Such an amino acid insertion, deletion or mutation can include, for example, a conservative amino acid substitution such as the conservative substitutions shown in Table 1. The substitutions shown are based on amino acid physico-chemical properties, and as such, are independent of organism. In some embodiments, the conservative amino acid substitution is a substitution listed under the heading of preferred substitutions.

TABLE 1

| Original | Exemplary | Preferred |
|---|---|---|
| Residue | Substitutions | Substitutions |
| Ala (A) | val; leu; ile | val |
| Arg (R) | lys; gln; asn | lys |
| Asn (N) | gln; his; lys; arg | gln |
| Asp (D) | glu | glu |
| Cys (C) | ser | ser |
| Gln (Q) | asn | asn |
| Glu (E) | asp | asp |
| Gly (G) | pro; ala | ala |
| His (H) | asn; gln; lys; arg | arg |
| Ile (I) | leu; val; met; ala; phe; | leu |
| | norleucine | |
| Leu (L) | norleucine; ile; val; | ile |
| | met; ala; phe | |
| Lys (K) | arg; gln; asn | arg |
| Met (M) | leu; phe; ile | leu |
| Phe (F) | leu; val; ile; ala; tyr | leu |
| Pro (P) | ala | ala |
| Ser (S) | thr | thr |
| Thr (T) | ser | ser |
| Trp (W) | tyr; phe | tyr |
| Tyr (Y) | trp; phe; thr; ser | phe |
| Val (V) | ile; leu; met; phe; | leu |
| | ala; norleucine | |

While in some embodiments, all codon pairs predicted to cause a translational pause or slowing are treated equally, in other embodiments, one or more different threshold levels can be established for differential treatment of codon pairs, where codon pairs above a highest threshold are the codon pairs most likely to cause a translational pause or slowing, and succeedingly lower codon pair threshold-based groups correspond to succeedingly lower likelihoods of the respective codon pairs causing a translational pause or slowing. Based on the codon pair groupings, different numbers or percentages of codon pairs can be removed for each of these different threshold-based groups. For example, 95% or more codon pairs above a highest threshold level can be removed, while 90% or less of all codon pairs between that level and an intermediate threshold level are removed. As contemplated herein, codon pairs likely to cause a translational pause or slowing can be segregated into two or more different threshold-based groups, three or more different threshold-based groups, four or more different threshold-based groups, five or more different threshold-based groups, six or more different threshold-based groups, or more. Discussion of specific thresholds are provided elsewhere herein; however, typically the higher the threshold, the higher the likelihood of a translational pause or slowing caused by a codon pair with a translational kinetics value greater than the threshold. In embodiments in which codon pairs likely to cause a translational pause or slowing can be segregated into two or more different threshold-based groups, different numbers or percentages of codon pairs can be removed for each codon pair group. For example, in one embodiment, at least 10%, 20%, 30%, 40%, 50%, 60%, 70%, 75%, 80%, 85%, 90%, 95%, 97%, 98% or 99% of codon pairs above a highest threshold are removed, while the same or a lower percentage of codon pairs are removed from codon pair groups corresponding to one or more lower thresholds. Typically, for each successively lower threshold group, the same or a lower percentage of codon pairs are removed. In one example, all codon pairs above a highest threshold are removed, while a codon pair above an intermediate threshold is removed only if the codon pair is located within an autonomous folding unit. In another example, all codon pairs above a highest threshold are removed, while a codon pair above an intermediate threshold is removed only if the codon pair can be removed without requiring a change in the encoded polypeptide sequence. In another example, all codon pairs above a highest threshold are removed, while a codon pair above a first higher intermediate threshold is removed only if the codon pair can be removed without changing the encoded polypeptide sequence or with only a conservative change to the encoded polypeptide sequence, while a codon pair above a second lower intermediate threshold is removed only if the codon pair can be removed without requiring any change in the encoded polypeptide sequence. While the above discussion has been applied to the use of a plurality of threshold levels, it will be readily apparent to one skilled in the art that, in the place of using threshold levels, an evaluation method can be used that determines the degree to which a codon pair should be removed according to the translational kinetics value of the codon pair, where the degree to which the codon pair should be removed can be counterbalanced by any of a variety of user-determined factors such as, for example, presence of the codon pair within or between autonomous folding units, and degree of change to the encoded polypeptide sequence.

In accordance with the methods and sequences provided herein, a translational kinetics value of a codon pair is a representation of the degree to which it is expected that a codon pair is associated with a translational pause. Methods of determining the translational kinetics value of a codon pair are discussed elsewhere herein. Such translational kinetics values can be normalized to facilitate comparison of translational kinetics values between species. In some embodiments, the translational value can be the degree of over-representation of a codon pair. An over-represented codon pair is a codon pair which is present in a protein-encoding sequence in higher abundance than would be expected if all codon pairs were statistically randomly abundant. When translational kinetics values of codon pairs are determined, a codon pair predicted to cause a translational pause or slowing is a codon pair whose likelihood of causing a translational pause or slowing is at least one standard deviation above the mean translational kinetics translational kinetics value, where a particular translational kinetics value “above” the mean translational kinetics value in this context refers to a translational kinetics value indicative of a greater likelihood of causing translational pausing or slowing, relative to a mean translational kinetics value, and is not strictly limited to a particular mathematical relationship (e.g., greater than the mean). In the methods provided herein, a threshold for the translational kinetics value of codon pairs that are predicted to cause a translational pause or slowing can be set in accordance with the method and level of stringency desired by one skilled in the art. For example, when it is desired to identify only a small number of the codon pairs most likely to cause a translational pause or slowing, a threshold value can be set to 5, or 3, or 2, or 1.5 standard deviations or more above the mean. Typical threshold values can be at least 1, 1.25, 1.5, 1.75, 2, 2.25, 2.5, 3, 3.5, 4, 4.5 and 5 standard deviations above the mean. As provided herein, a plurality of thresholds can be applied in the herein-provided methods in segregating codon pairs into a plurality of groups. Each threshold of such a plurality can be a different value selected from 1, 1.25, 1.5, 1.75, 2, 2.25, 2.5, 3, 3.5, 4, 4.5 and 5 standard deviations above the mean.

In some embodiments, translational kinetics of an mRNA into polypeptide can be changed to add or retain one or more translational pauses predicted to occur before, after or within an autonomous folding unit of a protein, or between autonomous folding units. While not intending to be limited to the following, it is proposed that translational pauses are present in wild type genes in order to slow translation of a nascent polypeptide subsequent to translation of a protein domain, thus providing time for acquisition of secondary and at least partial tertiary structure in the domain prior to further downstream translation. By modifying the translational kinetics of complex multi-domain proteins it may be possible to experimentally alter the time each domain has available to organize. Folding of a heterologously expressed gene having two or more independent domains can be altered by the presence of pause sites between the domains. Refolding studies indicate that the time it takes for a protein to settle into its final configuration may take longer than the translation of the protein. Pausing may allow each domain to partially organize and commit to a particular, independent fold. Other co-translational events, such as those associated with co-factors, protein subunits, protein complexes, membranes, chaperones, secretion, or proteolysis complexes, also can depend on the kinetics of the emerging nascent polypeptide. Pauses can be introduced by engineering one codon pair predicted to cause a translational pause or slowing, or two or more such codon pairs into the sequence to facilitate these co-translational interactions.

As such, provided herein is the recognition that the presence of codon pairs predicted to cause a translational pause or slowing in protein-encoding regions separating regions encoding different autonomous folding units of the protein can serve to pause translation and facilitate folding of the nascent translated protein, where autonomous folding units can be secondary structural elements such as an alpha helix, or can be tertiary structural elements such as a protein domain. Accordingly, provided herein are methods of changing translational kinetics of an mRNA into polypeptide by including or preserving one or more translational pauses predicted to occur before, after, or between autonomous folding units of a protein, thereby increasing the likelihood that the translated protein will be properly folded. In such embodiments, typically a translational pause is preserved, which refers to maintaining the same codon pair for a polypeptide-encoding nucleotide sequence that is expressed in the native host organism, or, when the polypeptide-encoding nucleotide sequence is heterologously expressed, changing the codon pair as appropriate to have a translational kinetics value comparable to or closest to the translational kinetics value of the native codon pair in the native host organism.

### Redesign of Polypeptide-Encoding Nucleotide Sequence

As provided herein, codon pairs are associated with translational pauses, and can thereby influence translational kinetics of an mRNA into polypeptide. Thus, the methods of changing translational kinetics provided herein will typically be performed by modifying or designing one or more nucleotide sequences encoding a polypeptide to be expressed. Accordingly, provided herein are methods of modifying a gene or designing a synthetic nucleotide sequence encoding the polypeptide encoded by the gene, collectively referred to herein as redesigning a polypeptide-encoding gene sequence or redesigning a polypeptide-encoding nucleotide sequence. Also included in the various embodiments provided herein are redesigned gene sequences encoding polypeptides that are not identical to the original gene.

Thus, provided herein are methods for redesigning a polypeptide-encoding nucleotide sequence to modify the translational kinetics of the polypeptide-encoding nucleotide sequence, where the polypeptide-encoding nucleotide sequence is altered such that one or more codon pairs have a decreased likelihood of causing a translational pause or slowing relative to the unaltered polypeptide-encoding nucleotide sequence. For example, one or more nucleotides of a polypeptide-encoding nucleotide sequence can be changed such that a codon pair containing the changed nucleotides has a translational kinetics value indicative of a decreased likelihood of causing a translational pause or slowing relative to the unchanged polypeptide-encoding nucleotide sequence.

While it will be understood by those of skill in the art that a redesigned polypeptide-encoding nucleotide sequence need not possess a high degree of identity to the polypeptide-encoding nucleotide sequence of the original gene, in some embodiments, the redesigned polypeptide-encoding nucleotide sequence will have at least 50%, 60%, 70%, 80%, 90%, 91%, 92%, 93%, 94%, 95%, 96%, 97%, 98% or 99% nucleotide identity with the polypeptide-encoding nucleotide sequence of the original gene. As used herein an “original gene” refers to a gene for which codon pair refinement is to be performed; such original genes can be, for example, wild type genes, naturally occurring mutant genes, other mutant genes such as site-directed mutant genes. In other embodiments, the polynucleotide sequence will be completely synthetic, and will bear much lower identity with the original gene, e.g., no more than 90%, 80%, 70%, 60%, 50%, 40%, or lower.

Because of the redundancy of the triplet genetic code it is possible to preserve amino acid sequence coding while redesigning the polypeptide-encoding gene nucleotide sequence. Polypeptide-encoding nucleotide sequences can be redesigned to be convenient to work with and specifically tailored to a particular host and vector system of choice. The resulting sequence can be designed to: (1) reduce or eliminate translational problems caused by inappropriate ribosome pausing, such as those caused by over-represented codon pairs or other codon pairs with translational values predictive of a translational pause; (2) have codon usage refined to avoid over-reliance on rare codons; (3) reduce in number or remove particular restriction sites, splice sites, internal Shine-Dalgarno sequences, or other sites that may cause problems in cloning or in interactions with the host organism; or (4) have controlled RNA secondary structure to avoid detrimental translational termination effects, translation initiation effects, or RNA processing, which can arise from, for example, RNA self-hybridization. When a synthetic polypeptide-encoding nucleotide sequence is to be used, this sequence also can be designed to avoid oligonucleotides that mishybridize, resulting in genes that can be assembled from refined oligonuclotides that by thermodynamic necessity only pair up in the desired manner, using methods known in the art, as exemplified in U.S. Patent Application No. 2005/0106590, which is hereby incorporated by reference in its entirety.

In some instances, it is not possible to modify the polypeptide-encoding nucleotide sequence to suitably modify the translational kinetics of the mRNA into polyepeptide without modifying the amino acid sequence of the encoded polypeptide. In such instances, an amino acid insertion, deletion or mutation can be introduced to yield a codon pair that is not predicted to cause a translational pause or slowing; or no change is made. In methods in which an amino acid insertion, deletion or mutation is made in order to change translational kinetics, the change is preferably predicted to not substantially influence the final three-dimensional structure of the protein and/or the activity of the protein. Such non-identical polypeptides can vary by containing one or more insertions, deletions and/or mutations. Although the nature and degree of change to the polypeptide sequence can vary according to the purpose of the change, typically such a change results in a polypeptide that is at least 50%, 60%, 70%, 80%, and more preferably at least 90%, 91%, 92%, 93%, 94%, 95%, 96%, 97%, 98% or 99% identical to the wild type polypeptide sequence.

In some embodiments, redesign of the polypeptide-encoding gene sequence is performed in conjunction with optimization of a plurality of parameters, where one such parameter is codon pair usage. Methods already known in the art for optimizing multiple parameters in synthetic nucleotide sequences can be applied to optimizing the parameters recited in the present claims. Such methods may advantageously include those exemplified in U.S. Patent App. Publication No. 2005/0106590, and R. H. Lathrop et al. “Multi-Queue Branch-and-Bound Algorithm for Anytime Optimal Search with Biological Applications” in Proc. Intl. Conf. on Genome Informatics, Tokyo, Dec. 17-19, 2001 pp. 73-82; in Genome Informatics 2001 (Genome Informatics Series No. 12), Universal Academy Press, which are incorporated herein by reference in their entireties. Briefly, in addition to optimizing the various parameters recited herein, an exemplary method for generating a synthetic sequence can also include dividing the desired sequence into a plurality of partially overlapping segments; optimizing the melting temperatures of the overlapping regions of each segment to disfavor hybridization to the overlapping segments which are non-adjacent in the desired sequence; allowing the overlapping regions of single stranded segments which are adjacent to one another in the desired sequence to hybridize to one another under conditions which disfavor hybridization of non-adjacent segments; and filling in, ligating, or repairing the gaps between the overlapping regions, thereby forming a double-stranded DNA with the desired sequence. This process can be performed manually or can be automated, e.g., in a general purpose digital computer. In one embodiment, the search of possible codon assignments is mapped into an anytime branch and bound computerized algorithm developed for biological applications.

Accordingly, provided herein are methods of designing a synthetic nucleotide sequence encoding a desired polypeptide, where the synthetic nucleotide sequence also is designed to have desirable translational kinetics properties, such as the removal of some or all codon pairs predicted to result in a translational pause or slowing. Such design methods include determining a set of partially overlapping segments with optimized melting temperatures, and determining the translational kinetics of the synthetic sequence, where if it is desired to change the translational kinetics of the synthetic gene, the sequences of the overlapping segments are modified and refined in order to approximate the desired translational kinetics while still possessing acceptable hybridization properties. In some embodiments, this process is performed iteratively. In some embodiments, graphical displays of values of observed versus expected codon pair frequencies are generated for the original sequence, the final sequence, and/or any intermediate sequences. In other embodiments, graphical displays of refined, possible, or improved translational kinetics values of codon pairs are generated for the original sequence, the final sequence, and/or any intermediate sequences. Such graphical displays can be used for analyzing the translational kinetics of the synthetic nucleotide sequence.

Those skilled in the art will recognize that various optimization methods can be used, e.g., simulated annealing, genetic algorithms, branch and bound techniques, hill-climbing, Monte Carlo methods, other search strategies, and the like. Thus, the methods provided herein for redesigning the polypeptide-encoding gene sequence that include optimization of a plurality of parameters, where one such parameter is codon pair usage, can be implemented in by applying those parameters to art-recognized algorithms or techniques. Advantageously, redesign of the polypeptide-encoding gene sequence is performed using an optimization method that designs a synthetic nucleotide sequence encoding the polypeptide to be expressed.

The polypeptide-encoding nucleotide sequence redesign methods provided herein can be employed where a plurality of properties of the polypeptide-encoding nucleotide sequence can be refined in addition to codon pair usage properties, where such properties can include, but are not limited to, melting temperature gap between oligonucleotides of synthetic gene, average codon usage, average codon pair chi-squared (e.g., z score), worst codon usage, worst codon pair (e.g., z score), maximum usage in adjacent codons, Shine-Dalgarno sequence (for E. coli expression), occurrences of 5 consecutive G's or 5 consecutive C's, occurrences of 6 consecutive A's or 6 consecutive T's, long exactly repeated subsequences, cloning restriction sites, user-prohibited sequences (e.g., other restriction sites), codon usage of a specific codon above user-specified limit, and out of frame stop codons (framecatchers). In embodiments that include expression in a eukaryotic host organism, additional properties that can be considered in a process of redesigning a polypeptide-encoding nucleotide sequence include, but are not limited to, occurrences of RNA splice sites, occurrences of polyA sites, and occurrence of Kozak translation initiation sequence. For example, a process of redesigning a polypeptide-encoding nucleotide sequence can include constraints including, but not limited to, minimum melting temperature gap between oligonucleotides of synthetic gene, minimum average codon usage, maximum average codon pair chi-squared (z score), minimum absolute codon usage, maximum absolute codon pair (z score), minimum maximum usage in adjacent codons, no Shine-Dalgarno sequence (for E. coli expression), no occurrences of 5 consecutive G's or 5 consecutive C's, no occurrences of 6 consecutive A's or 6 consecutive T's no long exactly repeated subsequences, no cloning restriction sites, no user-prohibited sequences (e.g., other restriction sites), and optionally no codon usage of a specific codon above user-specified limit. In embodiments that include expression in a eukaryotic host organism, additional contraints can include, but are not limited to, minimum occurrences of RNA splice sites, minimum occurrences of polyA sites, and occurrence of Kozak translation initiation sequence. A process of redesigning a polypeptide-encoding nucleotide sequence can include preferences including, but not limited to, prefer high average codon usage, prefer low average codon pair chi-squared, prefer larger melting temperature gap, prefer more out of frame stop codons (framecatchers), and optionally prefer evenly distributed codon usage. Any of a variety of nucleotide sequence refinement/optimization methods known in the art can be used to refine the polypeptide-encoding nucleotide sequence according to the codon pair usage properties, and according to any of the additional properties specifically described above, or other properties that are refined in nucleotide sequence redesign methods known in the art. In some embodiments, a branch and bound method is employed to refine the polypeptide-encoding nucleotide sequence according to codon pair usage properties and at least one additional property, such as codon usage.

In some embodiments, the methods provided herein can further include analyzing at least a portion of the candidate polynucleotide sequence in frame shift, and selecting codons for the candidate polynucleotide sequence such that stop codons are added to at least one said frame shift. In additional embodiments, the generating step further includes analyzing at least a portion of the candidate polynucleotide sequence in frame shift, and selecting codons for the candidate polynucleotide sequence such that one or more stop codons in one, two or three reading frames are added downstream of polypeptide-encoding region of the nucleotide sequence.

In some embodiments, methods are provided for redesigning a polypeptide-encoding gene for expression in a host organism, by providing a data set representative of codon pair translational kinetics for the host organism which includes translational kinetics values of the codon pairs utilized by the host organism, providing a desired polypeptide sequence for expression in the host organism, and generating a polynucleotide sequence encoding the polypeptide sequence by analyzing candidate nucleotides to select, where possible, codon pairs that are predicted not to cause a translational pause in the host organism, with reference to the data set, thereby providing a candidate polynucleotide sequence encoding the desired polypeptide.

Also provided herein are methods for redesigning a polypeptide-encoding gene for expression in a host organism, by providing a first data set representative of codon pair translational kinetics for the host organism which includes translational kinetics values of the codon pairs utilized by the host organism, providing a second data set representative of at least one additional desired property of the synthetic gene, providing a desired polypeptide sequence for expression in the host organism, and generating a polynucleotide sequence encoding the polypeptide sequence by analyzing candidate nucleotides to select, where possible, both (i) codon pairs that are predicted not to cause a translational pause in the host organism, with reference to the first data set, and (ii) nucleotides that provide a desired property, with reference to the second data set, thereby providing a candidate polynucleotide sequence encoding the desired polypeptide. In some embodiments, a branch and bound method is employed to refine the polypeptide-encoding nucleotide sequence according to codon pair usage properties of the first data set and according to the properties of the second data set. In some embodiments, the second data set contains of codon preferences representative of codon usage by the host organism, including the most common codons used by the host organism for a given amino acid.

The methods provided herein can further include analyzing the candidate polynucleotide sequence to confirm that no codon pairs are predicted to cause a translational pause in the host organism by more than a designated threshold. As described elsewhere herein, the likelihood that a particular codon pair will cause translational pausing or slowing in an organism (or the relative predicted magnitude thereof) can be represented by a translational kinetics value. The translational kinetics value can be expressed in any of a variety of manners in accordance with the guidance provided herein. In one example, a translational kinetics value can be expressed in terms of the mean translational kinetics value and the corresponding standard deviation for all codon pairs in an organism. For example, the translational kinetics value for a particular codon pair can be expressed in terms of the number of standard deviations that separate the translational kinetics value of the codon pair from the mean translational kinetics value. In methods that include analyzing the candidate polynucleotide sequence to confirm that no codon pairs are predicted to cause a translational pause in the host organism by more than a designated threshold, a threshold value can be at least 1, 1.25, 1.5, 1.75, 2, 2.25, 2.5, 3, 3.5, 4, 4.5 or 5 or more standard deviations above the mean translational kinetics value. Although such a method is described in terms of a binary scoring of a codon pair as either at least or less than the threshold value, one skilled in the art, in view of the teachings herein, will recognize that multiple thresholds can be used, or methods can be used that weight a codon pair along a continuum according to the translational kinetics value, based on the teachings provided herein and the general knowledge in the art.

In some embodiments, in addition to generating a candidate nucleotide sequence according to codon pair usage properties, the methods provided herein also include generating a candidate nucleotide sequence according to codon usage. As is known in the art, different organisms can have different preference for the three-nucleotide codon sequence encoding a particular amino acid. As a result, translation can often be improved by using the most common three-nucleotide codon sequence encoding a particular amino acid. Thus, some methods provided herein also include generating a candidate nucleotide sequence such that codon utilization is non-randomly biased in favor of codons most commonly used by the host organism. Codon usage preferences are known in the art for a variety of organisms and methods for selecting the more commonly used codons are well known in the art.

In some embodiments, the methods of redesigning a polypeptide-encoding nucleotide sequence are based on a plurality of properties, where a conflict in the preferred nucleotide sequence arising from the plurality of properties is determined in order to optimize the predicted translational kinetics. That is, when the plurality of properties being optimized would lead to more than one possible nucleotide sequence depending on which property is to be accorded more weight, typically, the conflict is resolved by selecting the nucleotide sequence predicted to be translated more rapidly, for example, due to fewer predicted translational pauses. In some embodiments, the methods of redesigning a polypeptide-encoding nucleotide sequence are based on a plurality of properties, where a conflict in the preferred nucleotide sequence arising from the plurality of properties is determined in order to optimize codon pair usage preferences. That is, when the plurality of properties being optimized would lead to more than one possible nucleotide sequence depending on which property is to be accorded more weight, typically, codon pair usage will be accorded more weight in order to resolve the conflict between the more than one possible nucleotide sequences. In one example, the methods provided herein can include identifying at least one instance of a conflict between selecting common codons and avoiding codon pairs predicted to cause a translational pause; in such instances, the conflict is resolved in favor of avoiding codon pairs predicted to cause a translational pause.

Some embodiments provided herein include generating a candidate polynucleotide sequence encoding the polypeptide sequence, the candidate polynucleotide sequence having a non-random codon pair usage, such that the codon pairs encoding any particular pair of amino acids have the lowest translational kinetics values. In some embodiments, the candidate polynucleotide sequence encoding the polypeptide sequence is generated and/or altered such that the encoded amino acid sequence is not altered. In some embodiments, the candidate polynucleotide sequence encoding the polypeptide sequence is generated and/or altered such that the three dimensional structure of the encoded polypeptide is not substantially altered. In some embodiments, the candidate polynucleotide sequence encoding the polypeptide sequence is generated and/or altered such that no more than conservative amino acid changes are made to the encoded polypeptide.

The methods provided herein can further include a step of refining or altering the candidate polynucleotide sequence in accordance with a second nucleotide sequence property to be refined. For example, in embodiments in which codon usage is also refined, the methods further include generating or refining a candidate polynucleotide sequence encoding a polypeptide sequence such that the candidate polynucleotide sequence has a non-random codon usage, where the most common codons used by the host organism are over-represented in the candidate polynucleotide sequence. The methods can include refining or altering the candidate polynucleotide sequence in accordance with any of a variety of additional properties provided herein, including but not limited to, melting temperature gap between oligonucleotides of synthetic gene, Shine-Dalgarno sequence, occurrences of 5 consecutive G's or 5 consecutive C's, occurrences of 6 consecutive A's or 6 consecutive T's long exactly repeated subsequences, cloning restriction sites, or any other user-prohibited sequences. Further, any of a variety of combinations of these properties can be additionally included in the nucleotide sequence refinement methods provided herein.

The method provided herein can further include an evaluation step in which after the candidate polynucleotide sequence is altered, the sequence is compared with at least a portion of a data set of a property against which the sequence was refined. In such methods, it is possible to compare the candidate sequence to the data set in order to determine whether or not the candidate sequence possesses the desired or acceptable properties with respect to the data set. For example, subsequent to a round of nucleotide sequence refinement, it can be evaluated whether or not the codon pairs of the candidate sequence have acceptable translational kinetics values. If the values are deemed to be acceptable or desired, no further sequence alteration is required with respect to the property. In view of the methods provided herein which can be directed to the refinement or optimization of a plurality of properties, the candidate nucleotide sequence can be compared to each property considered in the refinement, and, if the values for all properties are deemed to be acceptable or desired, no further sequence alteration is required. If the values for fewer than all properties are deemed to be acceptable or desired, the candidate nucleotide sequence can be subjected to further sequence alteration and evaluation.

Thus, it is contemplated herein that the sequence alteration steps of methods provided herein can be performed iteratively. That is, one or more steps of altering the nucleotide sequence can be performed, and the candidate nucleotide sequence can be evaluated to determine whether or not further sequence alteration is necessary and/or desirable. These steps can be repeated until values for all properties are deemed to be acceptable or desired, or until no further improvement can be achieved.

### Determination of Translational Kinetics Values for Codon Pairs

The methods and sequences provided herein include determination and use of translational kinetics values for codon pairs. As provided herein, such a translational kinetics value can be calculated and/or empirically measured, and the final translational kinetics value used in graphical displays and methods of predicting translational kinetics can be a refined value resultant from two or more types of codon pair translational kinetics information. The various types of codon pair translational kinetics information that can be used in refining or replacing a translational kinetics value for a codon pair include, for example, values of observed versus expected codon pair frequencies in a particular organism, normalized values of observed versus expected codon pair frequencies in a particular organism, the degree to which observed versus expected codon pair frequency values are conserved in related proteins across two or more species, the degree to which observed versus expected codon pair frequency values are conserved at predicted pause sites such as boundaries between autonomous folding units in related proteins across two or more species, the degree to which codon pairs are conserved at predicted pause sites across different proteins in the same species, and empirical measurement of translational kinetics for a codon pair.

The values of observed versus expected codon pair frequencies in a host organism can be determined by any of a variety of methods known in the art for statistically evaluating observed occurrences relative to expected occurrences. Regardless of the statistical method used, this typically involves obtaining codon sequence data for the organism, for example, on a gene-by-gene basis. In some embodiments, the analysis is focused only on the coding regions of the genome. Because the analysis is a statistical one, a large database is preferred. Initially, the total number of codons is determined and the number of times each of the 61 non-terminating codons appears is determined. From this information, the expected frequency of each of the 3721 (61²) possible non-terminating codon pairs is calculated, typically by multiplying together the frequencies with which each of the component codons appears. This frequency analysis can be carried out on a global basis, analyzing all of the sequences in the database together; however, it is typically done on a local basis, analyzing each sequence individually. This will tend to minimize the statistical effect of an unusually high proportion of rare codons in a sequence. After the frequency data is obtained, for each sequence in the database, the expected number of occurrences of each codon pair is calculated by, for example, multiplying the expected frequency by the number of pairs in the sequence. This information can then be added to a global table, and each next succeeding sequence can be analyzed in like manner. This analysis results in a table of expected and observed values for each of the 3271 non-terminating codon pairs. The statistical significance of the variation between the expected and observed values can then be calculated, and the resulting information can be used in further practice of the various examples and embodiments provided herein.

In some embodiments, the values of observed versus expected codon pair frequencies are chi-squared values, such as chi-squared 2 (chisq2) values or chi-squared 3 (chisq3) values. Methods for calculating chi-squared values can be performed according to any method known in the art, as exemplified in U.S. Pat. No. 5,082,767, which is incorporated by reference herein in its entirety. The result of chi-squared calculations is a list of 3,721 non-terminating codon pairs, each with an expected and observed value, together with a value for chi-squared (chisq1):

chisq1=(observed-expected)²/expected

In order to remove the contribution to chi-squared of non-randomness in amino acid pairs, a new value chi-squared 2 (chisq2) can be calculated as follows. For each group of codon pairs encoding the same amino acid pair (i.e., 400 groups), the sums of the expected and observed values are tallied; any non-randomness in amino acid pairs is reflected in the difference between these two values. Therefore, each of the expected values within the group is multiplied by the factor [sum observed/sum expected], so that the sums of the expected and observed values with the group are equal. The new chi-squared, chisq2, is evaluated using these new expected values. Calculation methods for removing the contribution to chi-squared of non-randomness in amino acid pairs are known in the art, as exemplified in Gutman and Hatfield, Proc. Natl. Acad. Sci. USA, (1989) 86:3699-3703.

Further, in order to remove the contribution to chi-squared of non-randomness in dinucleotides, a new value chi-squared 3 (chisq3) can be calculated. Correction is made only for those dinucleotides formed between adjacent codon pairs; any bias of dinucleotides within codons (codon triplet positions I-II and II-III) will directly affect codon usage and is, therefore, automatically taken into account in the underlying calculations. For each dinucleotide pair formed between adjacent codon pairs (i.e., 16 pairs), the sums of the expected and observed values are tallied; any non-randomness in dinucleotide pairs is reflected in the difference between these two values. Therefore, each of the expected values within the group is multiplied by the factor [sum observed/sum expected], so that the sums of the expected and observed values with the group are equal. The new chi-squared, chisq3, is evaluated using these new expected values.

As provided herein, and as will be readily apparent to those skilled in the statistical art, that further values chi-squared N (chisqN) could be calculated similarly by removing one or more other variables in like fashion.

Analyses of the E. coli, S. cerevisiae, and human databases illustrate two important features. First, there is a highly significant codon pair bias in all three species, even after the amino acid nearest neighbor bias (chisq2) and the dinucleotide bias (chisq3) are discounted. Second, the effect associated with dinucleotide bias, i.e., the difference between chisq2 and chisq3, is much more pronounced in eukaryotes than in E. coli. It is by far the predominant effect in mammals, representing two thirds of the amount of chisq2 in excess of its expectation in human. Mouse and rat data exhibit a very similar pattern. Dinucleotide bias represents a smaller effect in yeast, and only a very minor one in E. coli. Although the predominant dinucleotide bias in human is the well-known CpG deficit, other dinucleotides are also very highly biased. For example, there is a deficit of TA, as well as an excess of TG, CA and CT. Overall, the deficit of CpG contributes only 35% of the total dinucleotide bias in the human database, and 17% in yeast.

As provided herein, the values of observed versus expected codon pair frequencies in a host organism herein can be normalized. Normalization permits different sets of values of observed versus expected codon pair frequencies to be compared by placing these values on the same numerical scale. For example, normalized codon pair frequency values can be compared between different organisms, or can be compared for different codon pair frequency value calculations within a particular organism (e.g., different calculations based on input sequence information or based on different calculations such as chisq1 or chisq2 or chisq3). Typically, normalization results in codon pair frequency values that are described in terms of their mean and standard deviation from the mean.

An exemplary method for normalizing codon pair frequency values is the calculation of z scores. The z score for an item indicates how far and in what direction that item deviates from its distribution's mean, expressed in units of its distribution's standard deviation. The mathematics of the z score transformation are such that if every item in a distribution is converted to its z score, the transformed scores will have a mean of zero and a standard deviation of one. The z scores transformation can be especially useful when seeking to compare the relative standings of items from distributions with different means and/or different standard deviations. z scores are especially informative when the distribution to which they refer is normal. In a normal distribution, the distance between the mean and a given z score cuts off a fixed proportion of the total area under the curve.

An exemplary method for determining z scores for codon pair chi-squared values is as follows: First, a list of all 3721 possible non-terminating codon pairs is generated. Second, for the i^{th} codon pair, the i^{th} chi-squared value is calculated, where the i^{th} chi-squared value is denoted cᵢ. The chi-squared value, cᵢ, is given the sign of (observed-expected), so that over-represented codon pairs are assigned a positive cᵢ and under-represented codon pairs are assigned a negative cᵢ. The formula for cᵢ is:

cᵢ=sgn(obsᵢ−expᵢ)*(obsᵢ−expᵢ)²/expᵢ

Third, the mean chi-squared value is calculated where the mean is denoted m. The formula for the mean is:

m=(Σⁱcᵢ)/3721

where Σⁱ means sum over i. Fourth, the standard deviation of the chi-squared values is calculated, where the standard deviation is denoted s. The formula for the standard deviation is:

s=√(Σⁱ(cᵢ−m)²/3721)

where √ means square root. Fifth, for the i^{th} chi-squared value cᵢ, a z score is calculated by subtracting the mean then dividing by the standard deviation, wherein the i^{th} Z score is denoted zᵢ. The formula for the z score is:

zᵢ=(cᵢ−m)/s

The above-described values of observed codon pair frequency versus expected codon pair frequency can be used as first approximations of translational kinetics of a polypeptide-encoding nucleotide sequence. However, such values are not true predictors of translational kinetics, and refinement of such values to more accurately predict translational kinetics can be performed according to the methods provided herein. Thus, provided herein are methods of refining the predictive capability of a translational kinetics value of a codon pair in a host organism by providing an initial translational kinetics value based on the value of observed codon pair frequency versus expected codon pair frequency for a codon pair in a host organism, providing additional translational kinetics data for the codon pair in the host organism, and modifying the initial translational kinetics value according to the additional codon pair translational kinetics data to generate a refined translational kinetics value for the codon pair in the host organism. The translational kinetics data that can be used to refine translational kinetics values and methods of modifying translational kinetics values according to such additional translational kinetics data to generate a refined translational kinetics value for a codon pair in a host organism are provided below.

In one embodiment, translational kinetics data that can be used to refine translational kinetics values are based on recurrence of a codon pair and/or recurrence of a predicted translational kinetics value associated with a codon pair. Recurrence-based refinement of translational kinetics values is based on the investigation of multiple polypeptide-encoding nucleotide sequences to determine whether or not there are multiple occurrences of either codon pairs or predicted translational kinetics values in those sequences. Recurrence-based refinement of translational kinetics can be performed using any of a variety of known sequence comparison methods consistent with the examples provided herein. For purposes of exemplification, and not for limitation, the following example of recurrence-based refinement of translational kinetics is provided.

In one exemplary embodiment, the predicted translational kinetics value for a codon pair can be refined according to the degree to which observed versus expected codon pair frequency values are conserved in related proteins across two or more species. As provided herein, “related proteins” refers to proteins having homologous amino acid sequences and/or similar three dimensional structures. Related proteins having homologous amino acid sequences will typically have at least about 50%, 55%, 60%, 65%, 70%, 75%, 80%, 85%, 90%, 95% sequence identity. Related proteins having similar three dimensional structures will typically share similar secondary structure topology and similar relative positioning of secondary structural elements; exemplary related proteins having three dimensional structures are members of the same SCOP-classified Family (see, e.g., Murzin A. G., Brenner S. E., Hubbard T., Chothia C. (1995). SCOP: a structural classification of proteins database for the investigation of sequences and structures. J. Mol. Biol. 247, 536-540.).

The observed versus expected codon pair frequency values for any given codon pair can vary from species to species. However, as provided herein, evolutionarily related proteins in different species will typically conserve some or all translational pause or slowing sites. Based on this, an observed conservation of one or more predicted translational pause or slowing sites in evolutionarily related proteins of different species can confirm or increase the likelihood that a translational pause or slowing site is a functional translational kinetics signal. The codon pair located at the position on a protein that is confirmed as, or considered to have an increased likelihood of, containing an actual translational pause or slowing can itself be confirmed as being, or considered to have an increased likelihood of being, a functional translational kinetics signal. Similarly, a codon pair located at a position on a protein that is confirmed as not containing, or considered to have a decreased likelihood of containing, an actual translational pause or slowing, can itself be confirmed as not acting, or considered to have an decreased likelihood of acting, as a functional translational kinetics signal. Accordingly, initially predicted translational kinetics data, c.g., data based on values of observed codon pair frequency versus expected codon pair frequency, can be modified according to conserved codon pair frequency values across two or more species, which can lead to the codon pair being confirmed as: being a functional translational kinetics signal; being considered to have an increased likelihood of being a functional translational kinetics signal; being confirmed as not acting as an actual translational pause codon pair; or being considered to have a decreased likelihood of being a functional translational kinetics signal.

In another embodiment, the predicted translational kinetics value for a codon pair can be refined according to the presence of the codon pair at a location predicted by methods other than codon pair frequency methods to contain a translational pause or slowing site. One example of such a predicted location is a boundary location between autonomous folding units of a protein. While not intending to be limited to the following, it is proposed that translational pauses are present in wild type genes in order to slow translation of a nascent polypeptide subsequent to translation of a secondary structural element of a protein and/or a protein domain, thus providing time for acquisition of secondary and at least partial tertiary structure by the nascent protein prior to further downstream translation, and thereby allowing each domain to partially organize and commit to a particular, independent fold. As such, it is proposed herein that codon pairs can be associated with translational pauses between autonomous folding units of a protein, where autonomous folding units can be secondary structural elements such as an alpha helix, or can be tertiary structural elements such as a protein domain. Thus, the presence of a codon pair at a boundary location between autonomous folding units of a protein can confirm or increase the likelihood that the codon pair acts to pause or slow translation. Accordingly, predicted translational kinetics data, e.g., data based on values of observed codon pair frequency versus expected codon pair frequency, can be modified according to the presence of the codon pair at a boundary location between autonomous folding units of a protein, which can increase the likelihood of the codon pair acts to pause or slow translation. For example, an over-represented codon pair that is present at a boundary location between autonomous folding units of a protein can be confirmed as acting as a translational pause or slowing codon pair.

In the above embodiment, a single observation of the codon pair at a boundary location between autonomous folding units of a protein can confirm or increase the likely translational pause or slowing properties of a codon pair. However, typically a plurality of observations will be used to more accurately estimate the translational pause or slowing properties of a codon pair. Thus, methods of using, for example, predicted boundary locations can be combined with methods that are based on recurrence of a codon pair and/or recurrence of a predicted translational kinetics value associated with a codon pair in methods of refining a predicted translational kinetics value for a codon pair. For example, a protein present in two or more species can have conserved boundary locations between autonomous folding units of the protein, and recurrent presence of an over-represented codon pair at the boundary locations can confirm the likelihood of an actual translational pause at that boundary location, leading to confirmation, or increased likelihood, that the corresponding codon pair for the respective species acts as a translational pause or slowing codon pair. In another example, two or more proteins of the same species can have boundary locations between autonomous folding units, and recurrent presence of an over-represented codon pair at the boundary locations can confirm or indicate the likelihood of an actual translational pause at that boundary location, leading to confirmation or indication of increased likelihood that the corresponding codon pair acts as a translational pause or slowing codon pair.

Such recurrence-based methods also can be used to confirm or indicate increased likelihood that a non-over-represented codon pair (e.g., an under-represented codon pair or a represented-as-expected codon pair) acts as a translational pause or slowing codon pair. For example, two or more proteins of the same species can have boundary locations between autonomous folding units, and recurrent presence of a non-over-represented codon pair at the boundary locations, particularly if no over-represented codon pair is present, can confirm or indicate the likelihood of an actual translational pause at that boundary location, leading to confirmation or indication of increased likelihood that the corresponding codon pair acts as a translational pause or slowing codon pair.

Such recurrence-based methods also can be used to confirm or indicate the likelihood that a codon pair, such as an over-represented codon pair, does not act as a translational pause or slowing codon pair. For example, two or more proteins of the same species can have boundary locations between autonomous folding units, and consistent absence of a non-over-represented codon pair at the boundary locations can confirm or indicate increased likelihood that the codon pair does not act as a translational pause or slowing codon pair.

In another embodiment, the predicted translational kinetics value for a codon pair can be refined according to empirical measurement of translational kinetics for a codon pair. The influence of a codon pair on translational kinetics can be experimentally measured, and these experimental measurements can be used to refine or replace the predicted translational kinetics values for a codon pair. Several methods of experimentally measuring the translational kinetics of a codon pair are known in the art, and can be used herein, as exemplified in Irwin et al., J. Biol. Chem., (1995) 270:22801. One such exemplary assay is based on the observation that a ribosome pausing at a site near the beginning of an mRNA coding sequence can inhibit translation initiation by physically interfering with the attachment of a new ribosome to the message, and, thus, the codon pair to be assayed can be placed at the beginning of a polypeptide-encoding nucleotide sequence and the effect of the codon pair on translational initiation can be measured as an indication of the ability of the codon pair to cause a translational pause. Another such exemplary assay is based on the fact that the transit time of a ribosome through the leader polypeptide coding region of the leader RNA of the trp operon sets the basal level of transcription through the trp attenuator, and, thus, the codon pair to be assayed can be placed into a trpLep leader polypeptide codon region, and level of expression can be inversely indicative of the translational pause properties of the codon pair, due to a faster translation causing formation of a stemp-loop attenuator in the leader RNA, which results in transcriptional attenuation.

### Calculation Methods of Modifying Translational Kinetics Values Based on Additional Translational Kinetics Data

The translational kinetics data described herein can be combined in such a manner as to provide a refined translational kinetics value for a codon pair in a host organism. Methods of combining predictive data to arrive at a refined predictive value are known in the art and can be used herein.

Estimates for translational kinetics values are informed by a number of knowledge sources known to those skilled in the art, including but not limited to experimental measurement, conservation at protein structural boundaries and across homologous families, statistical inference from genomic sequence data, and the like as provided elsewhere herein. All these disparate knowledge sources must be integrated into an overall estimate for purposes of gene design and engineering. The general problem of integrating diverse and disparate knowledge sources is ubiquitous and well-studied in many different engineering fields, e.g., distributed sensor fusion in remote sensing, bagging classifiers in machine learning, heterogeneous database integration in data warehouses, or perceptual integration in artificial intelligence. Many useful and applicable approaches are known to the art.

While many approaches are possible, those skilled in the art agree that the method of Bayes [Bayes, T., 1764. An essay toward solving a problem in the doctrine of chances. Philosophical Transactions of the Royal Society of London 53:370-418. Reprinted pp. 131-153 in “Studies in the History of Statistics and Probability,” (ed. Pearson, E. S., Kendall, M. G.), Charles Griffin, London, 1970.] has rigorous foundations in probability and many successes in bioinformatics [Baldi, P., and Brunak, S., 2001. Bioinformatics: The Machine Learning Approach, MIT Press, Cambridge, Mass., USA]. Using the Bayesian approach as an example here, without intending to exclude other well-known approaches, the Bayesian approach seeks to choose an hypothesis H that is most probable given the observed data D.

Operationally, this means to choose H so as to maximize the probability of H given D, written P(H|D). By Bayes's rule, this may be rewritten as P(H|D)=P(D|H)*P(H)/P(D). This is equivalent to maximizing P(D|H)*P(H) because P(D) is constant for all H. The term P(H) is identified with the degree of belief in hypothesis H before the data was observed. The term P(D|H), read “the probability of D given H,” is identified with how well hypothesis H predicts the observed data D. Thus, the Bayesian approach seeks to find an hypothesis that is a priori likely and also explains the data well.

In this example, an hypothesis H is that a given sequence feature, e.g., a given codon pair, has utility for translational kinetics engineering, e.g., creates a translational pause site. The observed data D may have several observations, e.g., D=D1 & D2& D3& D4, where D1=an experimental measurement, D2=conserved at protein structural domain boundaries, D3=conserved across homologous protein families, and D4=indicated as over-represented by statistical analysis that yields a high chisq3 value. In this case, the term P(D|H)=P(D1& D2& D3& D4|H), which indicates to choose an hypothesis that explains each of the observed datum. Of course, different data sources have different rates and magnitudes of observational error. This falls naturally into the Bayesian approach because the probability framework extends naturally to encompass the probability of observational error, as P(D|H)=P(D|H)*P(D is correct)+P(not D|H)* P(D is not correct). For example, an experimental measurement D1 that has been confirmed by replicate testing would have a very low probability of error, and therefore it would dominate the estimate if available.

In the general case, where no experimental measurement is available, several Bayesian approaches are commonly employed. The simplest, which often works well, is named “Naive Bayes” because it assumes conditional independence among the individual observed data items. In this case, P(D|H)=P(D1& D2& D3& D4|H)=P(D1|H)*P(D2|H)*P(D3|H)*P(D4|H), where each of the individual terms is further expanded as P(Di|H)=P(Di|H)*P(Di is correct)+P(not D1|H)*P(Di is not correct) as indicated above. The terms P(Di is correct) and P(Di is not correct) can be estimated a priori by the correlation of Di with previous experimental measurements. The terms P(Di|H) and P(not D1|H) are obtained by observing whether or not hypothesis H is consistent with observed data item D1. More complex and powerful Bayesian approaches are also well known to the art. The fully general approach rewrites P(D|H)=P(D1& D2& D3& D4|H)=P(D4|D3& D2& D1& H)*P(D3|D2& D1& H)*P(D2|D1& H)*P(Di|H). Many other approaches, both Bayesian and others, are well known to the art.

By way of example, the translational kinetics values for a codon pair can be refined by consideration of, for example, chi-squared value of observed versus expected codon pair frequency and the degree to which codon pairs are conserved at predicted pause sites across different proteins in the same species, for example, at protein structure domain boundaries. An over-represented codon pair which is present with above-random frequency at boundary locations between autonomous folding units of proteins in the same species can have a translational kinetics value reflecting higher predicted translational pause properties of the codon pair. In contrast, an over-represented codon pair which is present with below-random frequency at boundary locations between autonomous folding units of proteins in the same species can have a translational kinetics value reflecting lower predicted translational pause properties of the codon pair.

As another example, the translational kinetics values for a codon pair can be refined by consideration of, for example, experimentally measured translation step times in one species and the degree to which codon pairs that correspond to measured pause sites in the first species are conserved across homologous proteins in other species, for example, in a multiple sequence alignment. When an over-represented codon pair in another species is aligned with above-random frequency to a codon pair that corresponds to a measured translation pause site in the first species, it can have a translational kinetics value reflecting higher predicted translational pause properties of that codon pair in the other species. In contrast, when an over-represented codon pair in another species is aligned with below-random frequency to a codon pair that corresponds to a measured translation pause site in the first species, it can have a translational kinetics value reflecting lower predicted translational pause properties of that codon pair in the other species.

In various embodiments described herein, translational kinetics values for codon pairs, including refined translational kinetics values, can be determined. The translational kinetic values can be organized according to the likelihood of causing a translational pause or slowing based on any method known in the art. In one example, the translational kinetic values for two or more codon pairs, up to all codon pairs, in an organism are determined, and the mean translational kinetics value and associated standard deviation are calculated. Based on this, the translational kinetics value for a particular codon pair can be described in terms of the multiple of standard deviations the translational kinetics value for the particular codon pair differs from the mean translational kinetics value. Accordingly, reference herein to mean translational kinetics values and standard deviations, whether or not applied to a particular expression of translational kinetics value, can be applied to any of a variety of expressions of translational kinetics values provided herein.

### Graphical Analysis of Translational Kinetics

Also provided herein are methods of analyzing translational kinetics of an mRNA into polypeptide encoded by a gene in a host organism by determining translational kinetics values for codon pairs in the host organism and generating a graphical display of the translational kinetics values of actual codon pairs of an original polypeptide-encoding nucleotide sequence of a heterologous gene as a function of codon position. Such a graphical display provides a visual display of the predicted translational influence, including translational pause or slowing for numerous or all codon pairs of a polypeptide-encoding nucleotide sequence. This visual display can be used in methods of modifying polypeptide-encoding nucleotide sequences in order to thereby modify the predicted translational kinetics of the mRNA into polypeptide in methods such as those provided herein. For example, the graphical displays can be used to identify one or more codon pairs to be modified in a polypeptide-encoding nucleotide sequence. The graphical displays can be used in analyzing a polypeptide-encoding nucleotide sequence prior to modifying the polypeptide-encoding nucleotide sequence, or can be used in analyzing a modified polypeptide-encoding nucleotide sequence to determine, for example, whether or not further modifications are desired.

The graphical displays can be created using translational kinetics values based on any of the methods for determining translational kinetics values provided herein or otherwise known in the art. For example, chi-squared as a function of codon pair position, chi-squared 2 as a function of codon position, or chi-squared 3 as a function of codon pair position, translational kinetics values thereof, empirical measurement of translational pause of codon pairs in a host organism, estimated translational pause capability based on observed presence and/or recurrence of a codon pair at predicted pause site, and variations and combinations thereof as provided herein.

The exact format of the graphical displays can take any of a variety of forms, and the specific form is typically selected for ease of analysis and comparison between plots. For example, the abscissa typically lists the position along the nucleotide sequence or polypeptide sequence, and can be represented by nucleotide position, codon position, codon pair position, amino acid position, or amino acid pair position. In such instances, the ordinate typically lists the translational kinetics value of the codon pair, such as, but not limited to, a translational kinetics value of codon pair frequency, including, but not limited to the z score of chisq1, the z score of chisq2, the z score of chisq3, the empirically measured value, and the refined translational kinetics value. In alternative embodiments, the sequence position can be plotted along the ordinate and the translational kinetics value can be plotted along the abscissa.

### Comparing Plots

Also contemplated herein are methods in which a set of graphical displays, including at least a first graphical display and a second graphical display, are prepared. These sets of displays can be compared in order to determine the difference in predicted translational efficiency or translational kinetics of the two plots. The plots can differ according to any of a variety of criteria. For example, each plot can represent a different polypeptide-encoding nucleotide sequence, each plot can represent a different host organism, each plot can represent differently determined translational kinetics values, or any combination thereof. As will be apparent to one skilled in the art, any number of different graphical displays can be compared in accordance with the methods provided herein, for example, 2, 3, 4, 5, 6, 7, 8 or more different graphical displays can be compared. Typically, two plots will represent different polypeptide-encoding nucleotide sequences, the same sequence in different host organisms, or different sequences in different host organisms.

Comparison of different graphical displays can be used to analyze the predicted change in translational kinetics as a result of the difference represented by the graphical displays. For example, comparison of the same polypeptide-encoding nucleotide sequence in different host organisms can be used to analyze any predicted transcriptional pauses that can be removed. Accordingly, provided herein are methods of analyzing translational kinetics of an mRNA into polypeptide in a host organism by comparing two graphical displays to understand or predict the differences in translational kinetics of the mRNA into polypeptide, where the differences in the graphical displays can be as a result of, for example, a difference in the polypeptide-encoding nucleotide sequence or a difference in the host organism. Upon determination of the differences in translational kinetics, it can be evaluated whether or not the change in translational kinetics as a result of the underlying difference between the two graphical displays is desirable. Such comparison methods also can lead to an identification of further modifications, e.g., further modifications to the polypeptide-encoding nucleotide sequence to further improve translational kinetics. Accordingly, it is contemplated herein that such comparison methods can be carried out iteratively.

In embodiments where it is desired to improve expression of a polypeptide-encoding nucleotide sequence in a particular heterologous host, a graphical display of the translational kinetics values of codon pairs for the original polypeptide-encoding nucleotide sequence in the heterologous host can be compared to a graphical display of the translational kinetics values of codon pairs for a modified polypeptide-encoding nucleotide sequence in the heterologous host, and it can be determined whether or not the modification to the polypeptide-encoding nucleotide sequence resulted in improved translational kinetics.

### Methods of Expressing Polypeptide

Also provided herein are methods of expressing a polypeptide-encoding nucleotide sequence generated by the methods provided herein. Methods of expressing polypeptides from polypeptide-encoding nucleotide sequences are known in the art, as exemplified, for example, by the techniques described in Maniatis et al., 1989, Molecular Cloning: A Laboratory Manual, Cold Spring Harbor Laboratory, N.Y. and Ausubel et al., 2006, Current Protocols in Molecular Biology, Greene Publishing Associates and Wiley Interscience, N.Y. The methods include inserting a polypeptide-encoding nucleotide sequence designed by the methods provided herein into a cell, and expressing the polypeptide-encoding nucleotide sequence under conditions suitable for gene expression. Additionally provided expression methods include cell-free expression systems as known in the art, where such methods include providing a polypeptide-encoding nucleotide sequence designed by the methods provided herein and contacting the polypeptide-encoding nucleotide sequence with a cell-free expression system under conditions suitable for protein translation.

The following examples are included for illustrative purposes only and are not intended to limit the scope of the invention.

### EXAMPLE 1

This example describes graphical displays of z scores for expression of a gene from a yeast retrotransposon in yeast and bacteria, and E. coli expression levels of different nucleotide sequences encoding the same protein. Ty3 is a retrotransposon of Saccharomyces cerevisiae, and is adapted to express its genes in S. cerevisiae using S. cerevisiae translational machinery. Thus, expression of Ty3 genes in S. cerevisiae represents native expression of these genes.

Chi-squared values for S. cerevisiae and E. coli were determined using previously reported methods (Hatfield and Gutman, “Codon Pair Utilization Bias in Bacteria, Yeast, and Mammals” in Transfer RNA in Protein Synthesis, Hatfield, Lee and Pirtle Eds. CRC Press (Boca Raton, La.) 1993). Briefly, nonredundant protein coding regions for each organism was obtained from GenBank sequence database (75,403 codon pairs in 177 sequences for S. cerevisiae, and 75,096 codon pairs in 237 sequences for E. coli) to determine an observed number of occurrences for each codon pair. The expected number of occurrences of each codon pair was calculated under the assumption that the codon pairs are used randomly. The chi-squared value “chisq1” was generated by the expected and observed values determined. The chsq1 was re-calculated to remove any influence of non-randomness in amino acid pair frequencies, yielding “chisq2.” The chsq2 was re-calculated to remove any influence of non-randomness in dinucleotide frequencies, yielding “chisq3.” z scores of chisq3 were calculated by determining the mean chisq3 value and corresponding standard deviation for all codon pairs, and normalizing each chisq3 value to be reported in terms of number of standard deviations from the mean chisq3 values.

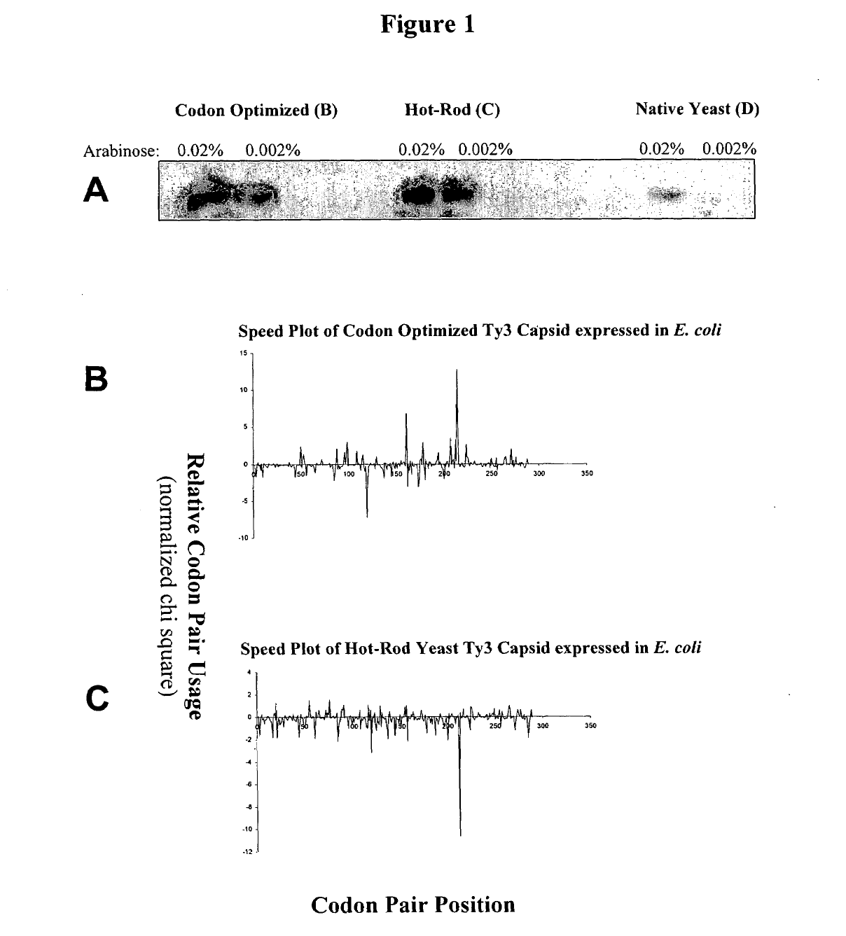

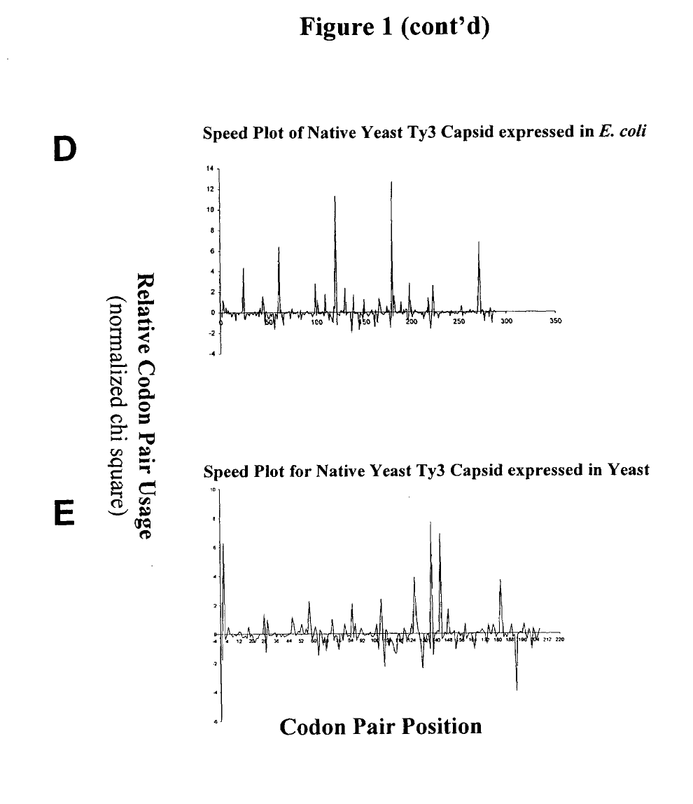

The nucleotide sequence for the gene encoding the Ty3 capsid protein was modified to optimize codon usage. A graphical display for the codon usage optimized gene (SEQ ID NO:3) encoding the Ty3 capsid protein (SEQ ID NO:4) expressed in E. coli was prepared by plotting z scores of chi-squared values for codon pair utililization in E. coli as a function of codon pair position. The graphical display is provided in FIG. 1B.

The nucleotide sequence for the gene encoding the Ty3 capsid protein was modified to no longer contain codon pairs having z scores in E. coli greater than 2. A graphical display for the codon pair utilization-modified gene (SEQ ID NO:5) encoding the Ty3 capsid protein (SEQ ID NO:6) expressed in E. coli was prepared by plotting z scores of chi-squared values for codon pair utililization in E. coli as a function of codon pair position. The graphical display is provided in FIG. 1C.

A graphical display for the native gene (SEQ ID NO:1) encoding the Ty3 capsid protein (SEQ ID NO:2) expressed in E. coli was prepared by plotting z scores of chi-squared values for codon pair utililization in E. coli as a function of codon pair position. The graphical display is provided in FIG. 1D.

A graphical display for the native gene (SEQ ID NO:1) encoding the Ty3 capsid protein (SEQ ID NO:2) in S. cerevisiae was prepared by plotting z scores of chi-squared values for codon pair utililization in S. cerevisiae as a function of codon pair position. The graphical display is provided in FIG. 1E.

Expression in E. coli of the codon optimized, codon pair utilization-based modification (hot-rod) and native Ty3 capsid was examined by Western blot analysis. pBAD-GAG was transformed into E. coli strain Top 10 (F-mcrA delta(mrr-hsdRMS-mcrBC) phi 801acZ deltaM15 deltalacX74 deoR recA1 araD139 delta(ara-leu) 7697 galU galK rpsL (StrR) endA1 nupG). An overnight culture was inoculated at 1:100 into 5 ml of LB medium plus 100 μg/ml ampicillin and grown at 37° C. to OD₆₀₀ of 0.5. Protein expression was induced by addition of 0.002 or 0.02% L-arabinose and grown for 3 hrs at 37° C. Cells were harvested by centrifugation and the cell pellet was resuspended in phosphate buffered saline. Cells were disrupted by sonication and supernatant and pellet fractions were resolved in a 4-20% SDS-polyacrylamide gel (Pierce). Proteins were transferred to Immobilon-P (Millipore, Bedford, Mass.) and were incubated with rabbit polyclonal anti-Ty3 CA (capsid) antibody diluted 1:20,000. Rabbit IgG was visualized using a HRP-conjugated secondary antibody and ECL+Plus (Amersham, Buckinghamshire, UK) according to manufacturer's instructions. The results of the Western blot analysis are provided in FIG. 1A.

FIG. 1A demonstrates that changes to a polypeptide-encoding nucleic acid sequence can increase expression of the polypeptide, particularly when the polypeptide is heterologously expressed. Specifically, FIG. 1A shows that the unmodified Ty3 capsid-encoding nucleic acid sequence yields low levels of Ty3 capsid expression in E coli. In contrast, a codon optimized Ty3 capsid-encoding nucleic acid sequence yields high levels of Ty3 capsid expression in E coli, and codon pair utilization-based modified Ty3 capsid-encoding nucleic acid sequence yields the highest levels of Ty3 capsid expression in E coli. Further demonstrated in FIG. 1 is the influence of the location in the polypeptide-encoding nucleotide sequence of an over-represented codon pair on the expression levels of the protein. FIG. 1D, corresponding to the lowest expression levels of Ty3 capsid, depicts two predicted pause sites within the first 70 codons. In contrast, FIG. 1B and FIG. 1E both depict predicted pause sites, but these pause sites are further downstream relative to the pause sites in FIG. 1D (note that although not depicted, Ty3 capsid is known to be expressed at high levels in S. cerevisiae). These results demonstrate that over-represented codon pairs closer to the amino terminus/translation initiation site can have a stronger influence on protein expression levels compared to over-represented codon pairs situated further downstream (i.e., closer to the carboxy terminus).

### EXAMPLE 2

This example describes the use of graphical displays of codon pair usage versus codon pair position in conjunction with knowledge of the secondary and tertiary structure of a polypeptide in evaluating over-represented codon pairs and the importance of pause sites between protein structural elements.

Normalized chi-squared values of codon pair utililization were plotted versus codon pair position for nucleic acid sequences encoding the capsid protein of the human immunodeficiency virus, HIV-1, and the capsid protein of the S. cereviseae retrotransposon, Ty3. The three-dimensional structure of the HIV-1 capsid protein has been determined experimentally, and the structural elements of the Ty3 capsid protein have been predicted by conventional threading methods to be similar to those of the HIV-1 capsid protein. The ribbon structure depicting alpha helices of each protein is shown above the respective graphical display. The regions of the abscissa indicating the amino terminal and the carboxy terminal domains of each protein are indicated by brackets. The thick black horizontal lines aligned in parallel with the codon pair position identify the positions of each alpha helix in each protein.

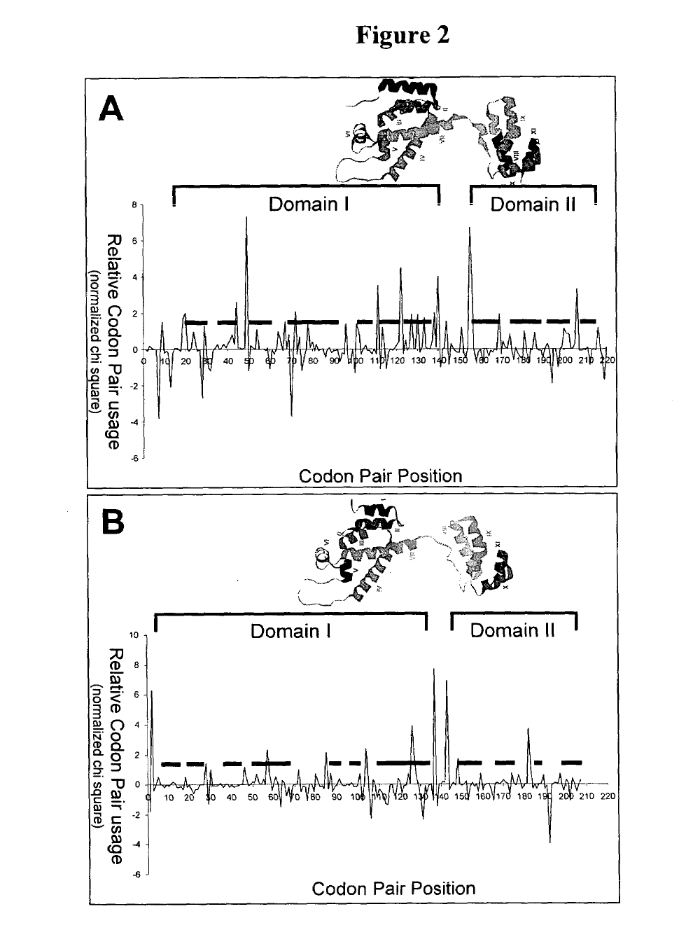

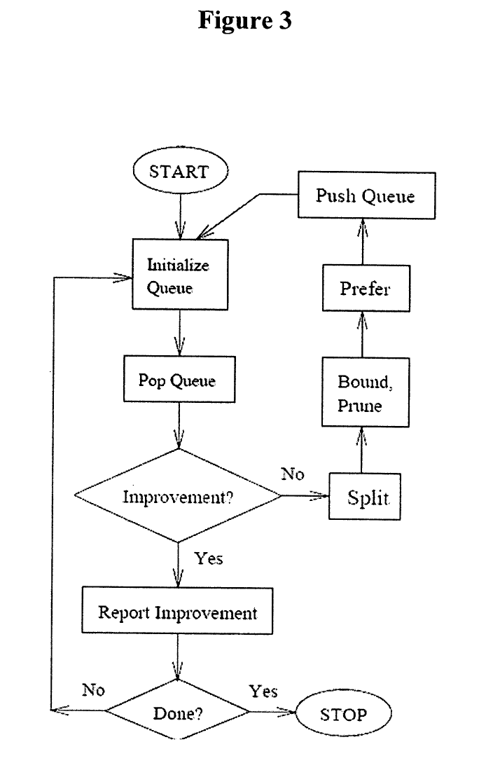

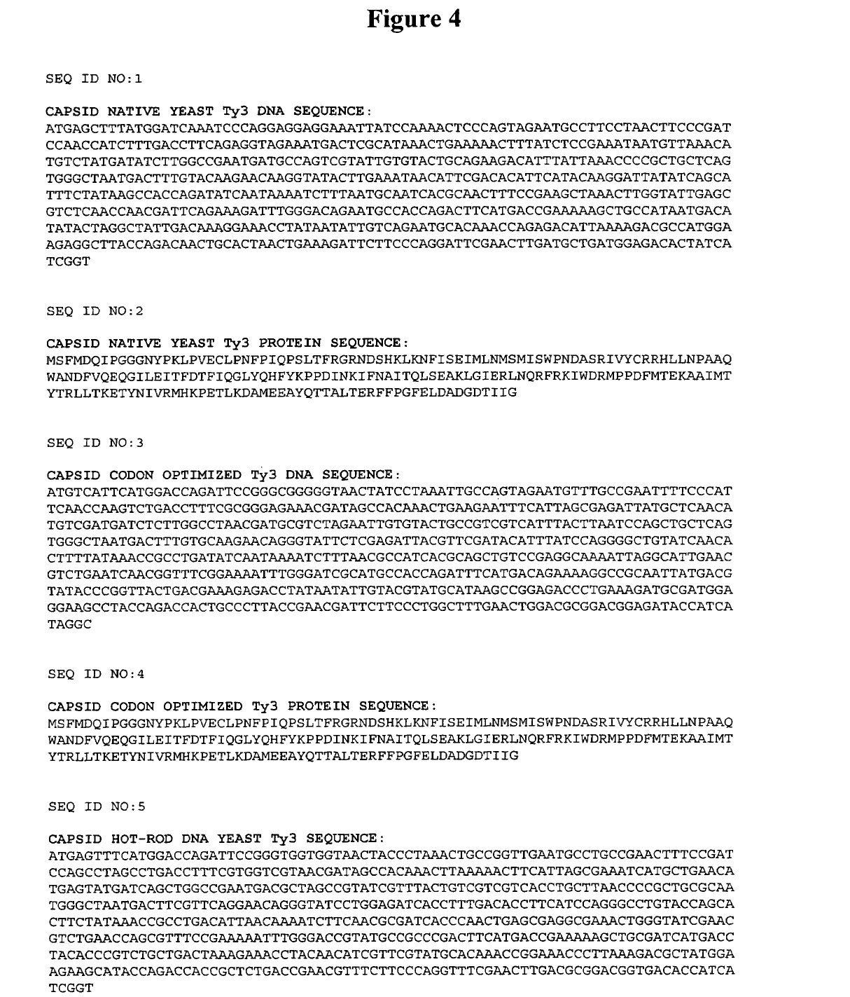

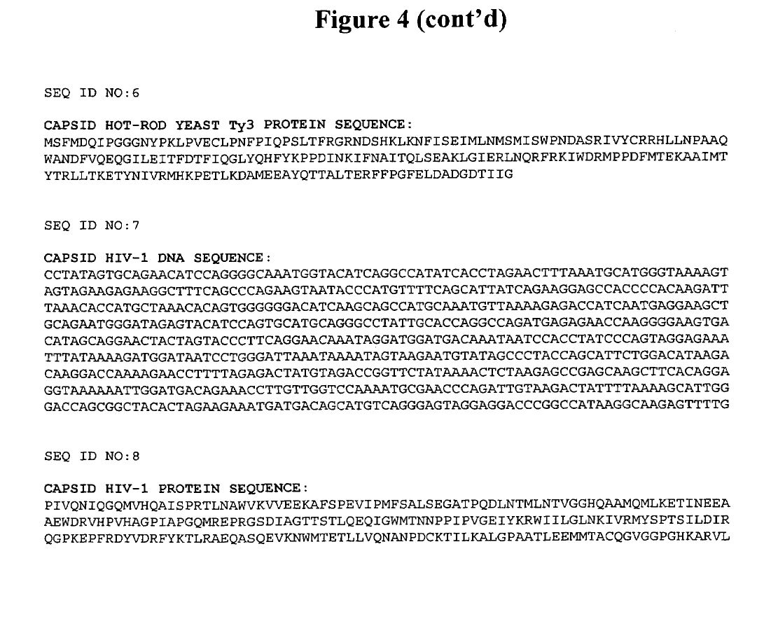

The plot of codon pair utililization versus codon pair position for the gene (SEQ ID NO:7) encoding the HIV-1 capsid protein (SEQ ID NO:8) expression in human is provided in FIG. 2A. In this figure, codon pairs having normalized chi-squared values greater than approximately 2 are not present in regions encoding amino acids located within an alpha helix, but are present in regions encoding amino acids located between alpha helices, and in particular, are present in regions immediately N-terminal to, or immediately C-terminal to, an alpha helix. In addition, two highly over-represented codon pairs are located between the N-terminal and C-terminal domains, and, in particular, the first is located immediately C-terminal to the N-terminal domain and the second is located immediately N-terminal to the C-terminal domain.

The plot of codon pair utililization versus codon pair position for the native gene (SEQ ID NO:1) encoding the Ty3 capsid protein (SEQ ID NO:2) expressed in S. cerevisiae is provided in FIG. 2B. Protein amino acid similarity between Ty3 and HIV-1 capsid protein is 16.6%, and DNA sequence similarity between Ty3 and HIV-1 capsid protein is considered to be even lower than 16.6%. Despite the lack of sequence similarity, FIG. 2B shows several similarities with FIG. 2A. Specifically, except for two instances, codon pairs having normalized chi-squared values greater than approximately 2 are not present in regions encoding amino acids located within an alpha helix. Further, numerous codon pairs having normalized chi-squared values greater than approximately 2 are present in regions between alpha helices, and in particular, are present in regions immediately N-terminal to, or immediately C-terminal to, an alpha helix. In addition, two highly over-represented codon pairs are located between the N-terminal and C-terminal domains, and, in particular, the one such codon pair is located immediately C-terminal to the N-terminal domain.

These plots demonstrate that it is possible to use graphical displays of translational kinetics to validate or obtain evidence confirming the likelihood that an over-represented codon pair indicates a translational pause site. These plots also demonstrate that it is possible to analyze polypeptide-encoding nucleotide sequences of structurally similar proteins from different species in order to validate or obtain evidence confirming the likelihood that an over-represented codon pair indicates a translational pause site, or validate or obtain evidence confirming the likelihood that a particular site in the sequence contains a translational pause. These plots also demonstrate that it is possible to analyze polypeptide-encoding nucleotide sequences in conjunction with the secondary and/or tertiary structure of the polypeptide in order to validate or obtain evidence confirming the likelihood that an over-represented codon pair indicates a translational pause site, or validate or obtain evidence confirming the likelihood that a particular site in the sequence contains a translational pause.

Since modifications will be apparent to those of skill in this art, it is intended that this invention be limited only by the scope of the appended claims.

What is claimed is:

1. A method for creating a synthetic gene for expression in a host organism, comprising:
a. providing a first data set of codon preferences that is representative of codon usage by the host organism, including most common codons used by the host organism for a given amino acid;
b. providing a second data set representative of codon pair translational kinetics for the host organism, including an association between codon pair selection and likelihood of at least some codon pairs causing a translational pause in the host organism;
c. providing a desired polypeptide sequence for expression in the host organism, said polypeptide sequence including at least twenty amino acids; and
d. generating a polynucleotide sequence encoding the polypeptide sequence by analyzing candidate codons for each amino acid of said desired polypeptide and analyzing candidate codons for each adjacent amino acid of said desired polypeptide, to select, where possible, both (i) codons that are most commonly used by the host organism, with reference to the first data set, and (ii) codon pairs that are not likely to cause a translational pause in the host organism, with reference to the second data set, thereby providing a candidate polynucleotide sequence encoding the desired polypeptide.

2. The method of claim 1, further comprising
e. analyzing the candidate polynucleotide sequence to ascertain the likelihood that codon pairs in said sequence will cause a translational pause in the host organism that is greater than a selected threshold likelihood level, and to ascertain that codon utilization is nonrandomly biased in favor of codons most commonly used by the host organism.

3. The method of claim 1, in which step d. includes
identifying at least one instance of a conflict between selecting common codons and avoiding codon pairs likely to cause a translational pause; and
resolving the conflict in favor of avoiding codon pairs likely to cause a translational pause.

4. The method of claim 1, in which step d. comprises:
f. generating a candidate polynucleotide sequence encoding the polypeptide sequence;
g. altering at least one codon of the candidate polynucleotide sequence to change a codon pair likely to cause a translational pause to a codon pair that is less likely to cause a translational pause, without altering the amino acid encoded thereby;
h. replacing at least one codon of the candidate polynucleotide sequence with a codon that is more commonly used in the host organism, without altering the amino acid encoded thereby;
i. after altering the candidate polynucleotide sequence, comparing the altered polynucleotide sequence with at least a portion of the first data set;
j. after altering the candidate polynucleotide sequence, comparing the altered polynucleotide sequence with at least a portion of the second data set;
k. individually repeating steps g., h., i., and j. a plurality of times, in any order, thereby altering a plurality of codons encoding a plurality of amino acids of said candidate polynucleotide sequence.

5. The method of claim 2, in which the candidate polynucleotide sequence of step e. is analyzed to confirm that no codon pairs are likely to cause a translational pause in the host organism by more than about 5, or 3, or 2, or 1.5 standard deviations above a mean translational kinetics value.

6. The method of claim 5, wherein the second data set representative of codon pair translational kinetics for the host organism comprises translational kinetics values of codon pairs in the host organism, and wherein the mean translational kinetics value is the mean of the translational kinetics values of the second data set.

7. The method of claim 1, in which step d. further comprises analyzing at least a portion of the candidate polynucleotide sequence in frame shift, and selecting codons for said candidate polynucleotide sequence such that stop codons are added to at least one said frame shift.

8. The method of claim 1, in which step d. further comprises providing a third data set, and analyzing at least a portion of the candidate sequence to reduce or eliminate occurrences of the property in the third data set, wherein the property of the third data set is selected from the group consisting of restriction site, Shine-Dalgarno sequence, occurrence of 5 consecutive G's, occurrence of 5 consecutive C's, occurrence of 6 consecutive A's, occurrence of 6 consecutive T's, long exactly repeated subsequence, and user-prohibited sequence.

9. The method of claim 1, in which step d. further comprises providing a third data set, and analyzing at least a portion of the candidate sequence to reduce or eliminate occurrences of the property in the third data set, wherein the property of the third data set is selected from the group consisting of occurrence of RNA splice site, occurrence of polyA site, and occurrence of Kozak translation initiation sequence.

10. The method of claim 1, in which step d. further comprises providing a third data set, and analyzing at least a portion of the candidate sequence to contain or increase the presence of a property in the third data set, wherein the property of the third data set is selected from the group consisting of Shine-Dalgarno translation initiation sequence, of Kozak translation initiation sequence, and out of frame stop codon.

11. The method of claim 1, wherein at least 50% of the codon pairs predicted to cause a translational pause are removed.

12. The method of claim 1, wherein at least 50% of the codon pairs having a translational kinetics value at least 5, or 3, or 2, or 1.5 standard deviations above a mean translational kinetics value are removed.

13. The method of claim 1, wherein the resultant polynucleotide sequence is a synthetic polynucleotide sequence.

14. The method of claim 1, wherein the resultant polynucleotide sequence has less than 90% identity to the original polynucleotide sequence.

15. The method of claim 1, wherein the amino acid sequence encoded by the resultant polynucleotide sequence is at least 90% identical to the original amino acid sequence.

16. The method of claim 1, wherein the resultant polynucleotide sequence does not contain a codon pair having a translational kinetics value at least 5, or 3, or 2, or 1.5 standard deviations above a mean translational kinetics value located in a region within an autonomous folding unit of the encoded polypeptide.

17. The method of claim 1, wherein the second data set contains translational kinetics values corresponding to each codon pair for a particular host organism.

18. The method of claim 17, wherein the translational kinetics values are based, at least in part, on a value selected from the group consisting of: normalized chi squared value of observed codon pair frequency versus expected codon pair frequency in the host organism; empirical measurement of the translational kinetics of a codon pair in the host organism; determination of a translational kinetics value of observed codon pair frequency versus expected codon pair frequency conserved across two or more species at a boundary location between autonomous folding units of a protein present in the two or more species, wherein the group of two or more species includes the host organism; translational kinetics value of observed codon pair frequency versus expected codon pair frequency that is positionally conserved across two or more species for a protein present in the two or more species, wherein the group of two or more species includes the host organism; and determination of a codon pair conserved across two or more proteins of the host organism at boundary locations between autonomous folding units of the two or more proteins.
